(19) United States
(12) Patent Application Publication
(10) Pub. No.: US 2002/0087851 A1
(43) Pub. Date: Jul. 4, 2002

(54) Microprocessor and an instruction converter

(75) Inventor: Shirou Yoshioka, Hyogo (JP)

Correspondence Address: Merchant & Gould P.C., P.O. Box 2903, Minneapolis, MN, 55402-0903, US

(73) Assignee: Matsushita Electric Industrial Co., Ltd.

(21) Appl. No.: 10/033,446

(22) Filed: Dec. 27, 2001

(30) Foreign Application Priority Data
Dec. 28, 2000 (JP) 2000-403540

(51) Int. Cl. G06F 9/00

(52) U.S. Cl. 712/239

(57) ABSTRACT

A microprocessor that can prevent the generation of the branch penalty even when a branch prediction is not hit, thereby improving the processing efficiency, and achieving low power consumption. The microprocessor employs a limited conditional branch instruction whose instruction to be executed next when the branch prediction is not hit is limited. The microprocessor includes a memory for storing instructions and a dedicated register for storing an op code of the limited instruction. When it is detected that the branch prediction is not hit by decoding the limited conditional branch instruction, the op code of the instruction to be executed next is provided from the dedicated register to the decoder and the operand of the instruction to be executed next is provided from the memory to the decoder. The decoder can start the decode operation because the op code is provided from the dedicated register in a short period, so the decode operation can be conducted within few machine cycles, the branch penalty generation can be prevented, and the processing efficiency is improved and low power consumption is achieved.

### BACKGROUND OF THE INVENTION

1. Field of the Invention

The present invention relates to a microprocessor which can execute condition branch instructions at a high speed frequency and an instruction converter that converts inputted instructions into the instructions used for the microprocessor

2. Description of the Related Art

As a conventional technology for reducing the branch penalty, a branch prediction technology and a delayed branch technology are known. FIG. 20 shows operations of the microprocessor employing a branch prediction function of the conventional technology. In the following example, operations are controlled for reducing the branch penalty under the prediction that the branch will be approved. In FIG. 20(A) and FIG. 20(A), “IF”, “DEC”, “EX”, “ME”, and “WB”, which are shown on the axis of ordinates, represent each stage of a five-step pipeline respectively. “IF” represents the instruction fetch stage, “DEC” represents the decode stage, “EX” represents the execution stage, “ME” represents the memory access stage, and “WB” represents the write-back stage. These stages correspond to four or five machine cycles. FIG. 20(A) shows the operations in the case that the branch actually is approved, in other words, in the case that the branch prediction actually hits. When the branch is approved, the branch penalty operation is not generated because the instruction is supplied from a target register TR that stores the instruction of the branch designation in the instruction sequence, and in the EX stage, the instruction of the branch designation is executed after executing the branch instruction without branch penalty.

However, in the case that the branch is not actually approved, in other words, in the case that the branch prediction does not actually hit, a branch penalty operation is generated. FIG. 20(B) shows the operations in the case that the branch is not actually approved. When the branch is not approved, the instruction located next to the branch instruction is executed. The pipeline operations should be re-started from the instruction located next to the branch instruction, so the branch penalty corresponding to 1 machine cycle is generated. The branch prediction function has an advantage because the branch penalty will become small in total if most branches are approved in the currently operated process typically seen in the loop process, and if the hit ratio of the branch prediction in the currently operated process is high.

Next, FIG. 21 shows the operation of the microprocessor employing the delayed branch function in the conventional technology. FIG. 21(A) corresponds to the case when a branch is actually approved, and FIG. 21(B) corresponds to the case when a branch is not actually approved. The delayed branch function uses a delayed slot located next to the branch instruction. The operation flow goes to the delayed slot after executing the branch instruction in order to ensure the correct pipeline flow, and the instruction to be fetched is determined after checking the branch result of the branch instruction. Either the instruction of the branch designation or the instruction located next to the branch instruction in the instruction sequence is fetched according to the branch result of the branch instruction. An instruction which is not affected by the branch result and which can be executed precedingly is assigned to the delayed slot, and this instruction assigned to the delayed slot is executed precedingly. If there is no such instruction, a NOP (no operation instruction) should be assigned to the delayed slot. When the delayed branch function is used, machine cycles corresponding to the delayed slot should be delayed in any case whatever the result of the branch operation, and as a result, machine cycles corresponding to the delayed slot become branch penalty when the NOP is assigned to the delayed slot.

A microprocessor including a branch prediction function shown in FIG. 20 in the conventional technology faces a problem that the scale of the hardware will become large because a plurality of target registers should be installed when a plurality of kinds of branch instructions are included in the processed instructions. In addition, there is another problem. Target registers can be reduced by pre-fetching the instruction of the branch designation, but when the branch is not actually approved, the branch penalty will be generated because the instruction fetch should be conducted again. The branch penalty becomes the maximum when the branch probability is 50%.

A microprocessor including a delayed branch function in the conventional technology faces a problem that the branch penalty corresponding to the number of the delayed slot is always generated whether the branch is approved or not because a NOP should be assigned in the delayed slot if a processing instruction cannot be held in the delayed slot.

As for the control of the home electronics, the percentage of branch instructions written as a case statement is high because many selection controls such as the switch input, the machine status, the external input, etc. are required. FIG. 22 shows the example of a case statement. FIG. 22(A) is a description of the case statement, and FIG. 22(B) is an assembler description as the result of compiling it. Here, “lD” shows the loading instruction, “cmp” shows comparative instruction, and “jz” shows the conditional branch instruction. With regard to a case statement, a branch probability is not as high as that of the loop operation. Thus, with conventional technology, the probability of the branch penalty becomes high, so the total penalty becomes large.

As mentioned above, when the branch penalty is generated, the processing efficiency of the microprocessor is decreased, and as a result, the power consumption will be increased. Therefore, with the foregoing in mind, it is an object of the present invention to provide a microprocessor that can prevent the deterioration of the processing efficiency and can achieve low power consumption.

### SUMMARY OF THE INVENTION

A microprocessor of the present invention, utilizes a branch prediction that the branch will be approved, employs a limited conditional branch instruction whose following instruction to be executed next when the branch prediction is not hit is limited, wherein, if it is detected that the branch is not actually approved in a decode stage for the limited conditional branch instruction, a fetch stage and a decode stage for the limited instruction are conducted within fewer machine cycles than required for a fetch stage and a decode stage for a normal instruction.

In this embodiment, when the microprocessor has a branch prediction that the branch will be approved and the branch is not actually approved, an instruction to be executed next is a limited instruction, so the fetch stage and the decode stage for it can be processed quickly within fewer machine cycles than required for a fetch stage and a decode stage for a normal instruction. Therefore, the generation of the branch penalty can be prevented and the processing efficiency is improved and low power consumption is achieved.

A microprocessor of the present invention, utilizes a branch prediction that the branch will be approved, employs a limited conditional branch instruction whose following instruction to be executed next when the branch prediction is not hit is limited. The microprocessor includes a first memory for storing instructions, a second memory for storing an “operation code (hereinafter op code)” of the next instruction when the branch prediction is not hit, wherein, if it is detected that the branch is not actually approved in the decode stage for the limited conditional branch instruction, the op code is provided from the second memory to the decoder quickly and the operand is provided from the first memory to the decoder quickly.

In this embodiment, when the microprocessor has a branch prediction that the branch will be approved and the branch prediction is not actually hit, an instruction to be executed next is limited, the op code is provided from the second memory to the decoder quickly and the operand is provided from the first memory to the decoder quickly, so the decoded result can be outputted to the execution stage in a short period. When the second memory is a high speed memory such as a dedicated register and a ROM dedicated for storing the op code, the op code can be supplied to the decoder quickly, therefore, the generation of the branch penalty can be prevented and the processing efficiency is improved and low power consumption is achieved.

A microprocessor of the present invention, utilizes a branch prediction that the branch will be approved, employs a limited conditional branch instruction whose following instruction to be executed next when the branch prediction is not hit is limited. The microprocessor comprises a first decoder used for decoding a normal instruction, and a second decoder used for decoding a limited instruction to be executed next when the branch of the limited conditional branch instruction is not approved, wherein the limited instruction to be executed next is decoded quickly within fewer machine cycles than required for a normal instruction, when it is detected that the branch is not approved by the first decoder as a result of decoding the limited conditional branch instruction, and the second decoder is used for the decode stage for the limited instruction to be executed next.

In this embodiment, when the microprocessor has a branch prediction that the branch will be approved and the branch prediction is not actually hit, an instruction to be executed next is limited, and the decode for the limited instruction is processed by the second decoder dedicated for the limited instruction, so the decode is conducted quickly within a short period. Therefore, the generation of the branch penalty can be prevented and the processing efficiency is improved and low power consumption is achieved.

An instruction converter of the present invention employs a limited conditional branch instruction whose next instruction to be executed next when the branch prediction is not hit is a limited instruction. When detecting the conditional branch instruction in the inputted instruction sequence, the instruction converter checks the instruction to be executed next when the conditional branch is not approved, and checks whether the relationship between the conditional branch instruction and the instruction to be executed next when the branch is not approved corresponds to the relationship between the limited conditional branch instruction and the instruction to be executed next when the branch is not approved. If it corresponds, the instruction converter converts the conditional branch instruction to the limited conditional branch instruction.

According to the instruction converter of the present invention, it inputs a program compiled by a conventional compiler and converts the conditional branch instruction included in the inputted program to the limited conditional branch instruction, and obtains the converted instruction sequence used for the microprocessor of the present invention.

A microprocessor of the present invention, utilizes a branch prediction that the branch will not be approved, employs a limited conditional branch instruction whose branch designation instruction to be executed next when the branch prediction is hit is limited, wherein, if it is detected that the branch is actually approved in decode stage for the limited conditional branch instruction, a fetch stage and a decode stage for a branch designation instruction are conducted quickly within fewer machine cycles than required for a fetch stage and a decode stage for a normal instruction.

In this embodiment, when the microprocessor has a branch prediction that the branch will not be approved and the branch prediction is actually hit, a branch designation instruction is limited, so the fetch stage and the decode stage of the branch designation instruction can be processed quickly within fewer machine cycles than required for the fetch stage and the decode stage for a normal instruction. Therefore, the generation of the branch penalty can be prevented and the processing efficiency is improved and low power consumption is achieved.

A microprocessor of the present invention, utilizes a branch prediction that the branch will not be approved, employs a limited conditional branch instruction whose branch designation instruction to be executed next when the branch prediction is actually hit is limited. The microprocessor comprises a first memory for storing instructions, a second memory for storing op code of the branch designation instruction to be executed next when the branch prediction is hit, wherein, if it is detected that the branch is actually approved in the decode stage for the limited conditional branch instruction, an op code is provided from the second memory to the decoder quickly and an operand is provided from the first memory to the decoder quickly.

In this embodiment, when the microprocessor has a branch prediction that the branch will not be approved and the branch prediction is not actually hit, a branch designation instruction to be executed next is limited, the op code is provided from the second memory to the decoder quickly and the operand is provided from the first memory to the decoder quickly, so the decoded result can be outputted to the execution stage in a short period. When the second memory is a high speed memory such as a dedicated register and a ROM dedicated for storing the op code, the op code can be supplied to the decoder quickly, therefore, the generation of the branch penalty can be prevented and the processing efficiency is improved and low power consumption is achieved.

A microprocessor of the present invention, utilizes a branch prediction that the branch will not be approved, employs a limited conditional branch instruction whose branch designation instruction to be executed next when the branch prediction is hit is limited. The microprocessor comprises a first decoder used for decoding a normal instruction, and a second decoder used for decoding a branch designation instruction to be executed next when the branch of the limited conditional branch instruction is approved, wherein the branch designation instruction is decoded quickly within fewer machine cycles than required for a normal instruction, and when it is detected that the branch is actually approved by the first decoder as a result of decoding the limited conditional branch instruction, the second decoder is used for the decode stage for the branch designation instruction to be executed next.

In this embodiment, when the microprocessor has a branch prediction that the branch will not be approved and the branch prediction is actually hit, a branch designation instruction to be executed next is limited, the decode for the branch designation instruction is processed by the second decoder dedicated for the limited instruction, so the decode is conducted quickly within a short period. Therefore, the generation of the branch penalty can be prevented and the processing efficiency is improved and low power consumption is achieved.

An instruction converter of the present invention employs a limited conditional branch instruction whose branch designation instruction to be executed next when the branch prediction is hit is limited. When detecting the conditional branch instruction in the inputted instruction sequence, the instruction converter checks the branch designation instruction to be executed next when the conditional branch is approved, and checks whether the relationship between the conditional branch instruction and the branch designation instruction corresponds to the relationship between the limited conditional branch instruction and the branch designation instruction. If it corresponds, the instruction converter converts the conditional branch instruction to the limited conditional branch instruction.

According to the instruction converter of the present invention, it inputs a program compiled by a conventional compiler and converts the conditional branch instruction included in the inputted program to the limited conditional branch instruction, and obtains the converted instruction sequence used for the microprocessor of the present invention.

A microprocessor of the present invention employs a limited unconditional branch instruction whose branch designation instruction to be executed next is limited, wherein, if the limited unconditional branch instruction is detected in a decode stage, a fetch stage and a decode stage for the branch designation instruction of the limited unconditional branch instruction are conducted within fewer machine cycles than required for a fetch stage and a decode stage for a normal instruction.

In this embodiment, the branch designation instruction of the limited unconditional branch instruction to be executed next is a limited instruction, so the fetch stage and the decode stage for it can be processed quickly within fewer machine cycles than required for the fetch stage and the decode stage for a normal instruction. Therefore, the generation of the branch penalty can be prevented and the processing efficiency is improved and low power consumption is achieved.

A microprocessor of the present invention employs a limited unconditional branch instruction whose branch designation instruction to be executed next is limited, wherein the microprocessor includes a first memory for storing instructions, and a second memory for storing an op code of the branch designation instruction of the limited unconditional branch instruction wherein, upon detecting the limited unconditional branch instruction in the decode stage, the op code is provided from the second memory to the decoder quickly and the operand is provided from the first memory to the decoder quickly.

In this embodiment, the branch designation instruction of the limited unconditional branch instruction to be executed next is a limited instruction, so the op code of the branch designation instruction is supplied from the second memory quickly, and the operand of the branch designation instruction is supplied from the first memory quickly, so the decode result can be supplied to the execution stage. When the second memory is a high speed memory such as a dedicated register or a ROM dedicated for storing the op code, the op code can be supplied to the decoder quickly, therefore, the generation of the branch penalty can be prevented, the processing efficiency is improved and low power consumption is achieved.

A microprocessor of the present invention employs a limited unconditional branch instruction whose branch designation instruction to be executed next is limited. The microprocessor comprises a first decoder used for decoding a normal instruction, a second decoder used for decoding a branch designation instruction of the limited unconditional branch instruction, wherein the branch designation instruction is decoded quickly within fewer machine cycles than required for a normal instruction, when the limited unconditional branch instruction is detected by the first decoder. The second decoder is used for the decode stage for the branch designation instruction of the limited unconditional branch instruction.

In this embodiment, the branch designation instruction of the limited unconditional branch instruction to be executed next is a limited instruction. By using the second decoder, which is dedicated to decode the branch designation instruction of the limited unconditional branch instruction, the decode stage for it can be conducted quickly. Therefore, the generation of the branch penalty can be prevented and the processing efficiency is improved and low power consumption is achieved.

An instruction converter of the present invention employs a limited unconditional branch instruction whose branch designation instruction to be executed next is limited. According to this scheme, wherein, when detecting the unconditional branch instruction in the inputted instruction sequence, the instruction converter checks the instruction to be executed subsequence to the unconditional branch instruction, and checks whether the relationship between the branch designation instruction and the unconditional branch instruction corresponds to the relationship between the branch designation instruction and the limited unconditional branch instruction. If it corresponds, the instruction converter converts the unconditional branch instruction to the limited unconditional branch instruction.

According to the instruction converter of the present invention, a program compiled by a conventional compiler is inputted and the unconditional branch instruction included in the inputted program is converted to the limited unconditional branch instruction, thereby yielding the converted instruction sequence used for the microprocessor of the present invention.

These and other advantages of the present invention will become apparent to those skilled in the art upon reading and understanding the following detailed description with reference to the accompanying figures.

### BRIEF DESCRIPTION OF THE DRAWINGS

FIG. 1 is a schematic block diagram showing a configuration of an instruction fetch part, a memory, and an instruction register according to Embodiment 1 of the present invention.

FIG. 2 is a timing chart showing an operation of a microprocessor according to Embodiment 1 of the present invention.

FIG. 3 is a schematic block diagram showing a configuration where the dedicated ROM is employed instead of the dedicated register shown in FIG. 2.

FIG. 4 is a schematic block diagram showing a configuration which mainly shows a decoder according to Embodiment 3 of the present invention.

FIG. 5 is a timing chart showing an operation of a microprocessor according to Embodiment 3 of the present invention.

FIG. 6 is a flowchart showing instruction converting steps in a converter according to Embodiment 4 of the present invention.

FIG. 7(A) is a schematic block diagram showing an example of a program written in case statement, FIG. 7(B) is a schematic block diagram showing a compiled result written in assembler, FIG. 7(C) is a schematic block diagram showing an example of a converted result of instructions.

FIG. 8 is a timing chart showing an operation of a microprocessor according to Embodiment 5 of the present invention.

FIG. 9 is a timing chart showing an operation of a microprocessor according to Embodiment 7 of the present invention.

FIG. 10 is a flowchart showing instruction converting steps in a converter according to Embodiment 8 of the present invention.

FIG. 11(A) is a schematic block diagram showing an example of a program written in case statement, FIG. 11(B) is a schematic block diagram showing a compiled result written in assembler, FIG. 11(C) is a schematic block diagram showing an example of a converted result of instructions.

FIG. 12 is a schematic block diagram showing a configuration of Embodiment 9 of the present invention.

FIG. 13 is a timing chart showing an operation of a microprocessor according to Embodiment 9 of the present invention.

FIG. 14 is a schematic block diagram showing a configuration where the dedicated ROM is employed instead of the dedicated register according to Embodiment 10.

FIG. 15 is a timing chart showing an operation of a microprocessor according to Embodiment 11 of the present invention.

FIG. 16 is a flowchart showing instruction converting steps in a converter according to Embodiment 12 of the present invention.

FIG. 17 is a program list showing an example written in case statement.

FIG. 18 is a list written in the assembler language showing the compile result of the program written in case statement shown in FIG. 17.

FIG. 19 is a program list showing the instruction sequence after converting by the instruction converter according to Embodiment 12 of the present invention.

FIG. 20 is a timing chart showing an operation of a microprocessor including a branch prediction function in the conventional technology.

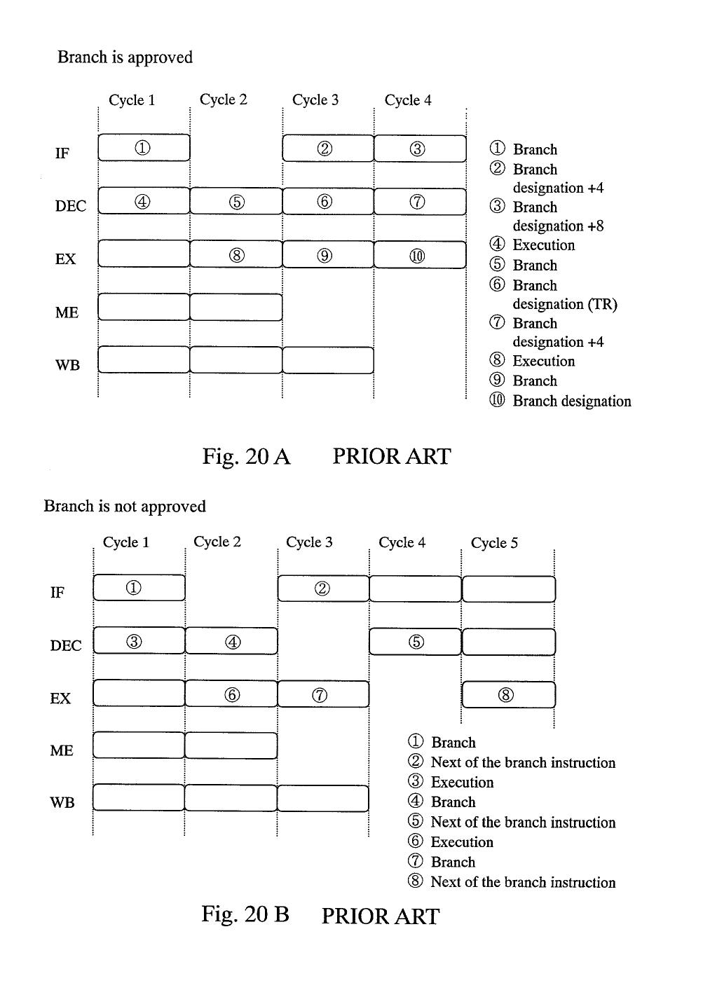

FIG. 21 is a timing chart showing an operation of a microprocessor including a delayed branch function in the conventional technology.

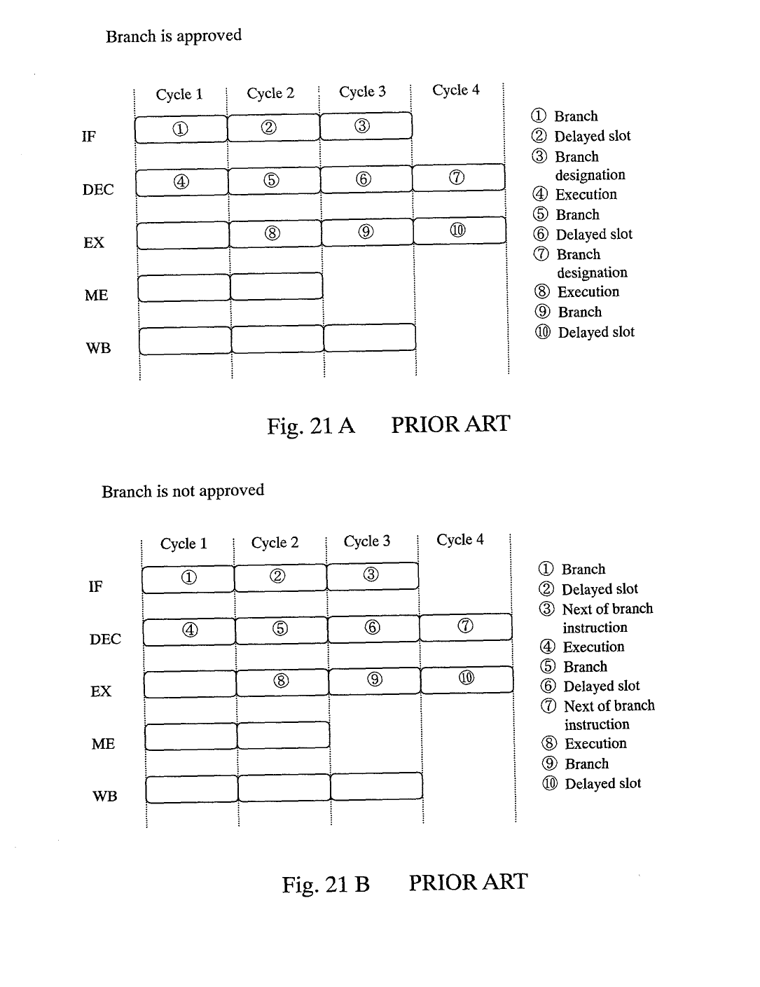

FIG. 22(A) is a schematic block diagram showing an example of a program written in case statement, FIG. 22(B) is a schematic block diagram showing a compiled result written in assembler.

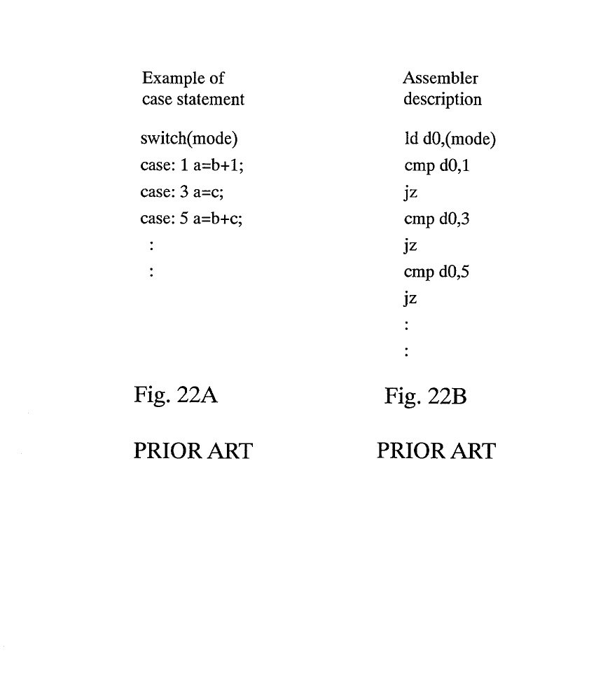

### DESCRIPTION OF THE PREFERRED EMBODIMENTS

Hereinafter, the present invention of the microprocessor will be described by way of embodiments with reference to the accompanying drawing.

Embodiment 1

Hereinafter, the present invention of the microprocessor will be described by way of embodiments with reference to the accompanying drawing.

The microprocessor of Embodiment 1 is the one to prevent the branch penalty generation even when the branch prediction that the branch is approved is not actually hit. It is different from the case of the loop operation, where the probability of the approval of the branch condition is not so high in the program written by the case statement. In addition, the comparative operation is often put just behind the branch instruction. The microprocessor of this invention employs the limited conditional branch instruction. A limited conditional branch instruction of the present invention is a type conditional branch instruction. It is an instruction whose following instruction to be executed next when the branch is not approved is limited. When it is detected that the branch is not approved as a result of decoding of the limited conditional branch instruction, the generation of the branch penalty can be prevented by conducting a fetch stage and a decode stage for the following instruction quickly within the fewer machine cycles than required for conducting a fetch stage and a decode stage for normal instruction.

The microprocessor of Embodiment 1 includes a first memory for storing instructions and a second memory for storing the op code of the instruction executed in the next operation when the branch is not approved as a means for conducting a fetch stage and a decode stage of the following instruction within few machine cycles. When it is detected that the branch is not approved as a result of decoding of the limited conditional branch instruction, the op code is provided from the second memory to the decoder quickly and the operand is provided from the first memory to the decoder quickly.

Particularly, in Embodiment 1, a dedicated register served as a high-speed memory that is dedicated for storing an op code of the instruction executed next. Because the dedicated register is used as the second memory in Embodiment 1, the op code to be executed next can be read quickly. In addition, because the dedicated register is a rewritable memory, the op code can be rewritten according to the necessity.

In this Embodiment 1, when the branch prediction that branch will be approved is not actually hit, the instruction which will be executed in the following operation is the instruction located next to the limited conditional branch instruction in the instruction sequence.

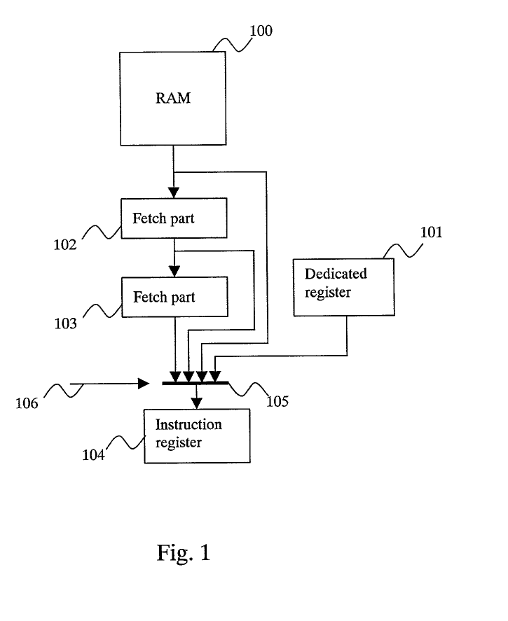

FIG. 1 is a schematic block diagram showing a configuration of an instruction fetch part, a memory, and an instruction register as a configuration achieving the above mentioned process. In FIG. 1, 100 denotes a RAM as a first memory storing instructions, 101 denotes a dedicated register as a second memory storing the op code of the instruction that is located next to the limited conditional branch instruction in the instruction sequence, 102 denotes a fetch part fetching an instruction from the RAM 100, 103 denotes a fetch part fetching data from the fetch part 102, 105 denotes a selection part selecting and outputting data selected from the RAM 100, the fetch part 102, the fetch part 103 or the dedicated register 100. 106 denotes a selection control signal indicating the selection of the selection part 105. 104 denotes an instruction register storing the output of the selection part 105 and outputting the data to the decoder.

The dedicated register 101 as the second memory, which is a high speed memory, stores the op code of the instruction located next to the limited conditional branch instruction. For example, the dedicated register 101 stores a comparative instruction “cmp” as the limited instruction located next to the limited conditional branch instruction. Therefore, the op code of the instruction located next to the limited conditional branch instruction can be provided quickly due to loading the op code in the dedicated register 101 beforehand.

In FIG. 1, the instruction stored in the RAM 100 is fetched by the two stages of the fetch part 102 and the fetch part 103. The selection part 105 selects the data of the RAM 100, the fetch part 102, the fetch part 103, and dedicated register 101 according to the selection control signal 106 and passes the selected data to the instruction register 104.

Therefore, the instruction register 104 can receive four values selectively. Even when the branch prediction is not hit and the branch is not approved as a result of decoding the limited conditional branch instruction, the op code prepared beforehand is supplied from the dedicated register 101 as the second memory to the instruction register 104 through the selection part 105 quickly, and the operand is supplied from the RAM 100 to the instruction register 104 through the selection part 105 quickly, so the fetch stage and decode stage of the instruction located next to the limited conditional branch instruction can be operated within one machine cycle. In general, the decode time mainly depends on the decode operation for the op code. On the other hand, the decode operation for the operand does not take a lot of time because it is decoded only to select the register. Therefore, the decode operation is started early by supplying the op code from the dedicated register 101, and the decode operation can be completed within one machine cycle.

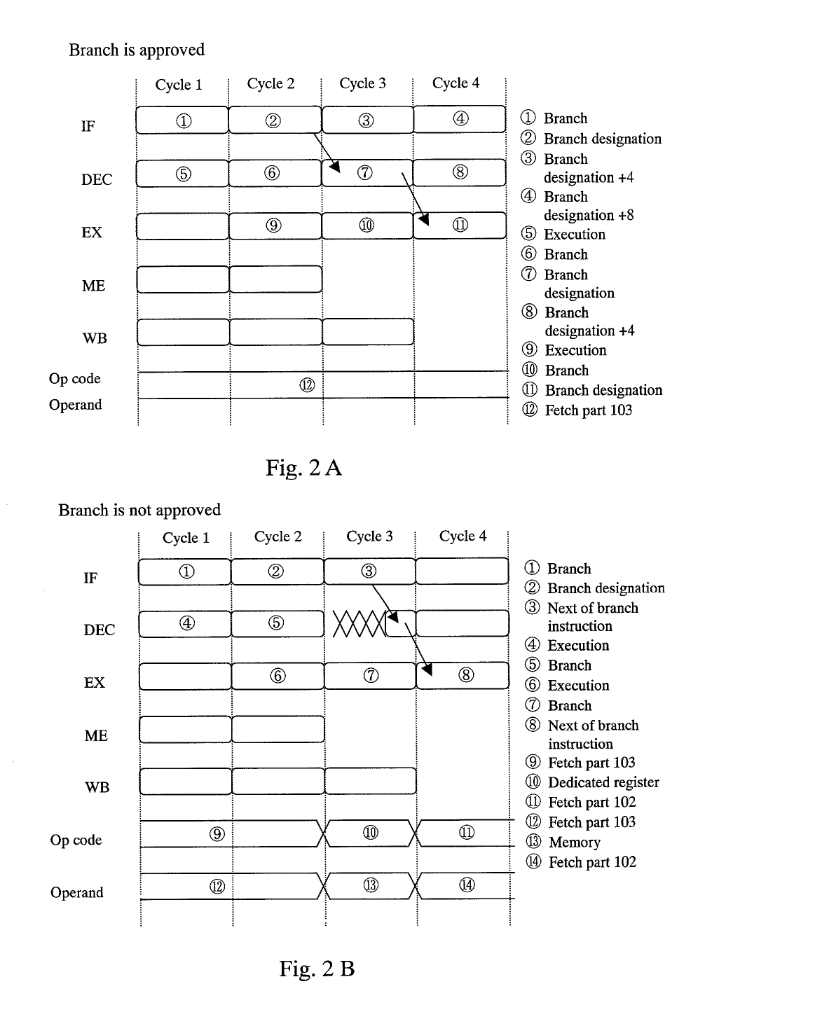

FIG. 2 is a timing chart showing an operation of a microprocessor according to Embodiment 1 of the present invention. In FIG. 2, IF, DEC, EX, ME, and WB of the vertical axis mean each stage of a five-step pipeline respectively, IF denotes the instruction fetch stage, DEC denotes the decode stage, EX denotes the execution stage, ME denotes the memory access stage, and WB denotes the write back stage. These are describing four cycles. Moreover, the supply origins of the op code part and the operand part supplied to the instruction register 104 are shown under WB in FIG. 2.

FIG. 2(A) shows the operation when the branch prediction that the branch will be approved is hit.

At cycle 1, the limit conditional branch instruction is fetched. In this case, the limited conditional branch instruction is stored in the fetch part 103. Moreover, the limited conditional branch instruction is pre-decoded and the branch designation address is calculated.

Next, at cycle 2, the instruction of the branch designation is fetched in the fetch part 102 under the prediction that the branch will be approved. In DEC stage, the limited conditional branch instruction is decoded, and it is detected that the branch is approved.

Next, at cycle 3, the instruction located next to the branch designation is fetched in the fetch part 102, and the instruction of the branch designation is decoded in the DEC stage. As shown above, when the branch prediction that the branch will be approved is hit, the branch penalty according to the branch processing is not generated.

FIG. 2(B) shows the operation when the branch prediction that the branch will be approved is not hit.

At cycle 1, the limited conditional branch instruction is fetched. In this case, the limited conditional branch instruction is stored in the fetch part 103. Moreover, the limited conditional branch instruction is pre-decoded and the branch designation address is calculated.

Next, at cycle 2, the instruction of the branch designation is fetched in the fetch part 102 under the prediction that the branch will be approved. In DEC stage, the limited conditional branch instruction is decoded, and it is detected that the branch is not approved.

Next, at cycle 3, the op code of the branch designation instruction is supplied from the dedicated register 101 as the second memory to the instruction register 104 quickly and the operand is supplied from the RAM 100 as the first memory to the instruction register 104 quickly. The op code of the limited conditional branch instruction is limited the same as the op code stored in the dedicated register, so the decode of the op code of the instruction located next to the limited conditional branch instruction can be started immediately by supplying the op code from the dedicated register 101 to the instruction register 104. Moreover, even if the operand is supplied from the RAM 100, the operand can be decoded within the period of cycle 3 because the decode operation of the operand is only selecting the register. The fetch stage of cycle 3, the operand of the limited conditional branch instruction from RAM 100, at the same time, the instruction located next to the limited conditional branch instruction is fetched in the fetch part 102.

Next, at cycle 4, the instruction located two instructions away from the limited conditional branch instruction is fetched in the fetch part 102. The instruction located next to the limit conditional branch instruction is decoded.

As shown above, when the branch prediction that the branch will be approved is not hit, the branch penalty according to the branch processing is not generated.

According to the microprocessor of Embodiment 1, when the branch prediction that the branch will be approved is not hit, the op code of the instruction located next to the limited conditional branch instruction is supplied from the dedicated register to the decoder quickly, and the operand of that instruction is supplied from the memory to the decoder quickly, and the decoded result is outputted to the execution stage. Therefore, the generation of the branch penalty can be prevented and the processing efficiency is improved and low power consumption is achieved.

Embodiment 2

The microprocessor of Embodiment 2 is the same configuration as that of Embodiment 1. In Embodiment 2, a dedicated ROM is used as the second memory instead of the dedicated register used in Embodiment 1. The dedicated ROM is a ROM dedicated for storing an op code of the instruction located next to the limited conditional branch instruction in the instruction sequence.

In Embodiment 2, the dedicated ROM is used as the second memory, the op code can be read quickly. In addition, the manufacturing cost will be decreased compared to the case when the dedicated register is used.

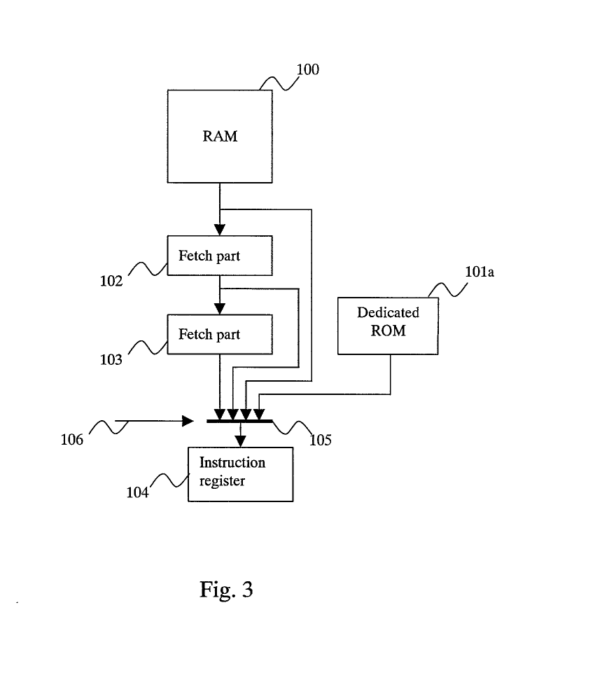

FIG. 3 is a diagram showing the configuration of the microprocessor of Embodiment 2. In the configuration of Embodiment 1 shown in FIG. 1, the second memory is the dedicated register 101. However, in the configuration of Embodiment 2 shown in FIG. 3, the second memory is a dedicated ROM 101a instead. This dedicated ROM 101a stores the op code of the instruction that is located next to the limited conditional branch instruction (this instruction is executed when the limited conditional branch instruction is executed and the branch condition is not approved). This dedicated ROM 101a served as high-speed memory. For example, the op code of the instruction such as “cmp” is stored in the dedicated ROM 101a as the limited instruction. Because the op code of such a predetermined instruction is prepared in advance, the op code can be provided quickly.

Other elements, such as the RAM 100 as the first memory, the fetch part 102, the fetch part 103, the instruction register 104, the selection 105 and the selection control signal 106 are the same as that of FIG. 1, so the explanation for them will be omitted here.

Herein, the selection part 105 selects and outputs a value from one of the following: the RAM 100, the fetch part 102, fetch part 103, and dedicated ROM 101a.

The selection control signal 106 indicates which value should be selected among those 4 values.

According to the microprocessor of Embodiment 2, the second memory is the dedicated ROM; the op code that is located next to the limited conditional branch instruction can be read quickly, and the manufacturing cost will be decreased comparing with the case when the dedicated register is used. In Embodiment 1, the second memory is the dedicated register, so the initialization process for the dedicated register should be described in the initialization routine program executed at the boot up processing. However, in Embodiment 2, the second memory is the dedicated ROM, so the initialization process for the dedicated ROM is not necessary and the initialization routine program is not necessary to be described in the boot up processing.

Embodiment 3

The microprocessor of Embodiment 3 of the present invention will be described with reference to the accompanying drawing. The same as Embodiment 1, the microprocessor of Embodiment 3 prevents the branch penalty generation when the branch prediction that the branch will be approved is not hit. Moreover, the same as Embodiment 1, the limited conditional branch instruction is used in the microprocessor of this Embodiment 3. The microprocessor of Embodiment 3 includes a first decoder used for decoding general instructions and a second decoder used for decoding the instruction located next to the limited conditional branch instruction wherein the second decoder is a dedicated decoder for decoding the instruction located next to the limited conditional branch instruction and it can decode the instruction within fewer machine cycles than required for decoding general instructions. In the DEC stage, as a basic decoder, the first decoder is used. If the instruction to be processed is the limited conditional branch instruction, the first decoder decodes it and detects that the branch is not approved, and then the second decoder is used in the next DEC stage for the instruction located next to the limited conditional branch instruction in order to decode it quickly within few machine cycles.

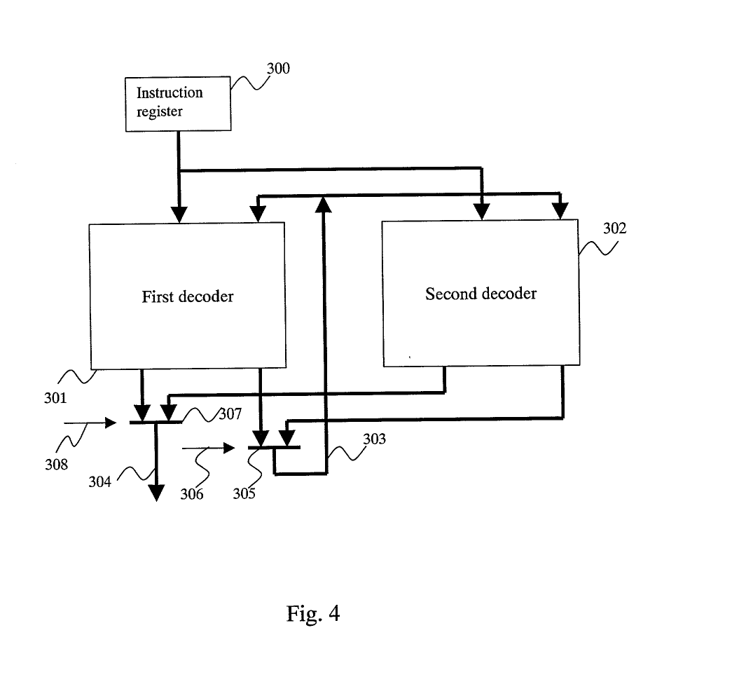

FIG. 4 is a schematic block diagram showing a configuration that mainly shows a decoder according to Embodiment 3 of the present invention. In FIG. 4, 300 denotes an instruction register, 301 denotes a first decoder used mainly in a DEC stage, 302 denotes a second decoder used when the branch prediction is not hit, 303 denotes a decoder selection signal, 304 denotes a control signal for controlling ALU etc., 305 denotes a selection part for selecting either of the first decoder or the second decoder, 306 denotes a selection control signal for notifying the selection part 305 of the decoder to be selected, 307 denotes a selection part for selecting either of the control signal for the first decoder or the control signal for the second decoder, and 308 denotes a selection control signal for notifying the selection part 307 of the control signal to be selected.

In Embodiment 3, the first decoder is provided as a basic decoder for conducting the DEC stage of the general instructions, furthermore, the second decoder is provided as a dedicated decoder for conducting the DEC stage of the instruction located next to the limited conditional branch instruction. For example, as a limited conditional branch instruction, the comparative instruction “cmp” is assumed. The second decoder has a dedicated module for decoding the specified limited instruction, so the hardware scale is compact and the decode time is short. By this arrangement, in the case that the branch prediction is not hit, IF stage and DEC stage for the instruction located next to the limited conditional branch instruction can be conducted within machine cycles corresponding to the machine cycles for the EX stage of the limited conditional branch instruction. Therefore, the branch penalty generation can be prevented.

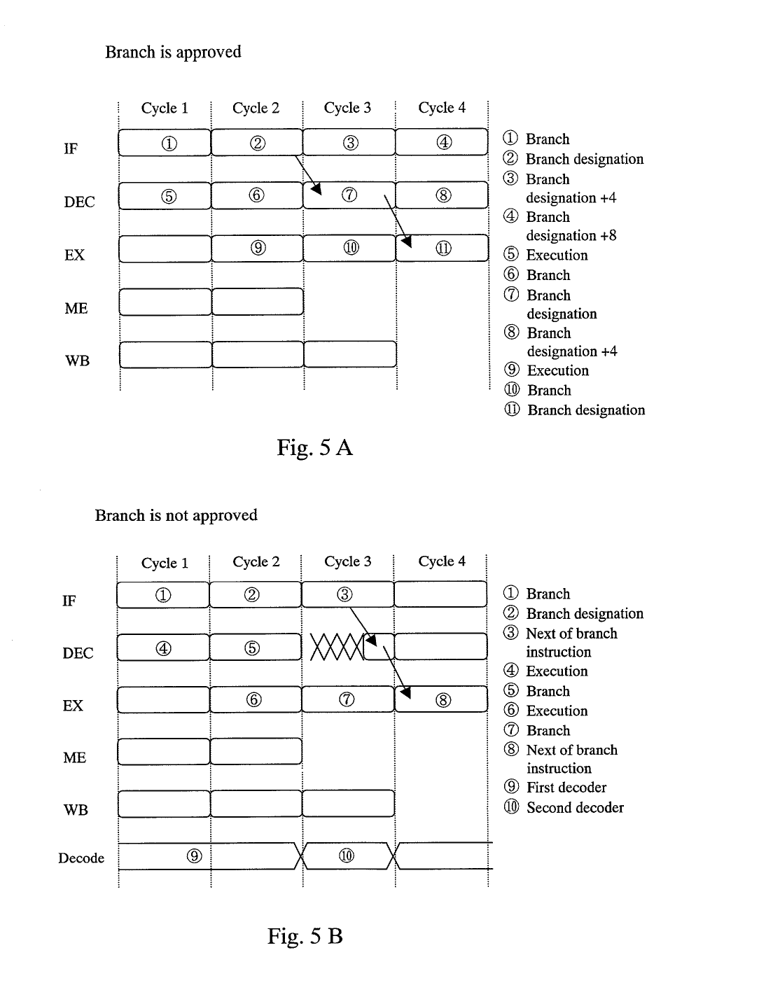

FIG. 5 is a timing chart showing an operation of a microprocessor shown in FIG. 4 according to Embodiment 3 of the present invention. In FIG. 5, the same as FIG. 2, IF, DEC, EX, ME, and WB of the vertical axis mean each stage of a five-step pipeline respectively. IF denotes the instruction fetch stage, DEC denotes the decode stage, EX denotes the execution stage, ME denotes the memory access stage, and WB denotes the write back stage. These are describing four cycles. In FIG. 5(B), the decoder to be used is shown under WB.

FIG. 5(A) shows the operation when the branch prediction is hit and the branch is actually approved. In this Embodiment 3, all DEC stages are conducted by the first decoder 301.

First, at the cycle 1, a limited conditional branch instruction is fetched from the fetch part 103. Moreover, at the cycle 1, the limited conditional branch instruction is pre-decoded and the address of the branch designation is calculated.

Next, at the cycle 2, the instruction located at the branch designation is fetched in the fetch part 102 under the branch prediction that the branch will be approved. Moreover, the limited conditional branch instruction is decoded by the first decoder 301 and it is detected that the branch is approved.

Next, at the cycle 3, the instruction located next to the limited conditional branch instruction is fetched in the fetch part 102, and the instruction located at the branch designation is decoded by the first decoder 301.

As shown above, in the case that the branch prediction is hit, the branch penalty is not generated.

FIG. 5(B) shows the operation when the branch prediction is not hit and the branch is not actually approved. Comparing with the case that the branch prediction is hit, the DEC stage at the cycle 3 is different in using the second decoder 302.

First, at the cycle 1, a limited conditional branch instruction is fetched from the fetch part 103. Moreover, at the cycle 1, the limited conditional branch instruction is pre-decoded and the address of the branch designation is calculated.

Next, at the cycle 2, the instruction located at the branch designation is fetched in the fetch part 102 under the branch prediction that the branch will be approved. Moreover, the limited conditional branch instruction is decoded by the first decoder 301 and it is detected that the branch is not approved.

Next, at the cycle 3, it has already been detected that the branch prediction is not approved in the DEC stage of the cycle 2, so the second decoder 302 is used instead. In this case, the instruction located next to the limited conditional branch instruction is provided from the memory 100 to the instruction register 300, and the instruction stored in the instruction register 300 and the decoder selection signal 303 are provided to the second decoder 302 and the provided instruction is decoded. Herein, the instruction located next to the limited conditional branch instruction is limited, the second decoder 302 is the dedicated decoder having the dedicated module to decode the limited instruction, and the second decoder 302 can decode such limited instruction in a short period. Moreover, the instruction located two instructions away from the limited conditional branch instruction is fetched in the fetch part 102.

Next, at the cycle 4, the output of the decoder 302 is selected by the selection part 305 and 307 and provided to the EX stage. Moreover, the first decoder 301 conducts DEC stage by using the output signal of the second decoder 302 and the instruction register 300.

Although not shown in FIG. 5, after the cycle 4, the selection part 307 and the selection part 305 selects the output of the first decoder 302 until the next limited conditional branch instruction is coming.

As shown above, in the case that the branch prediction is not hit, the branch penalty is not generated.

According to the microprocessor of Embodiment 3 of the present invention, in the case that the branch prediction that the branch will be approved is not hit, the instruction located next to the limited conditional branch instruction is limited, and the second decoder is a dedicated decoder having the dedicated module to decode such limited instruction, so the second decoder can decode such limited instruction in a short period. As a result, IF stage and DEC stage for the instruction located next to the limited conditional branch instruction can be conducted within machine cycles corresponding to the machine cycles for the EX stage of the limited conditional branch instruction. Therefore, the branch penalty generation can be prevented and the processing efficiency is improved and low power consumption is achieved.

Embodiment 4

An instruction converter of Embodiment 4 of the present invention is shown. The instruction converter of Embodiment 4 generates the instruction sequence used for the microprocessor of the present invention shown in Embodiment 1 to Embodiment 3. The instruction converter of the present invention inputs the compiled instruction sequence compiled by the conventional compiler, and detects a conditional branch instruction that can be converted to a limited conditional branch instruction used in a microprocessor of the present invention, and converts the conditional branch instruction into the limited conditional branch instruction for the microprocessor of the present invention.

The instruction converter of Embodiment 4 generates the instruction sequence used for the microprocessor shown in Embodiment 1 to Embodiment 3 operated with the branch prediction that the branch will be approved. In this case, a conditional branch instruction whose next instruction is limited is determined as a limited conditional branch instruction. When the instruction converter of the present invention detects a conditional branch instruction in the inputted instructions, checks the next instruction in the case that the branch is not approved, and checks if the relationship of the conditional branch instruction and the instruction to be executed after the conditional branch instruction in the case that the branch will not be approved corresponds to the relationship of the limited conditional instruction and the instruction to be executed after the limited conditional branch instruction in the case that the branch will not be approved, and if it corresponds, the conditional branch instruction is converted to the limited conditional branch instruction.

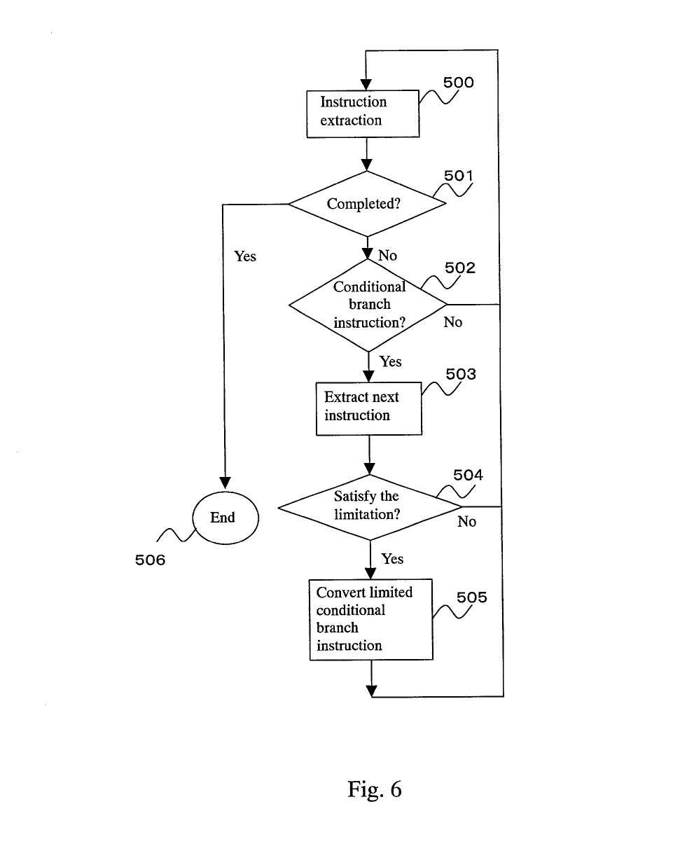

FIG. 6 is a flowchart showing instruction converting steps in the instruction converter according to Embodiment 4 of the present invention. In FIG. 6, 500 denotes an instruction extraction step for extracting an assembler language one by one from the inputted compiled instruction. 501 denotes an extraction completion judgement step for judging whether or not all the instructions are extracted. 502 denotes a conditional branch instruction extraction step for judging whether or not the extracted instruction is the conditional branch instruction. 503 denotes a limited instruction extraction step for extracting the instruction located next to the conditional branch instruction which are extracted in the step 503. 504 denotes a limitation judgement step for judging whether or not the extracted instruction at step 503 is the limited conditional branch instruction. 505 denotes a limited conditional branch instruction converting step for converting the conditional branch instruction extracted at step 500 to the limited conditional branch instruction when it is detected that the instruction extracted at step 503 satisfies the limitation at the limitation judgement step 504. 506 denotes an end step for ending the instruction converting processing.

The instruction converting operation in the instruction converter of the present invention is described with an example.

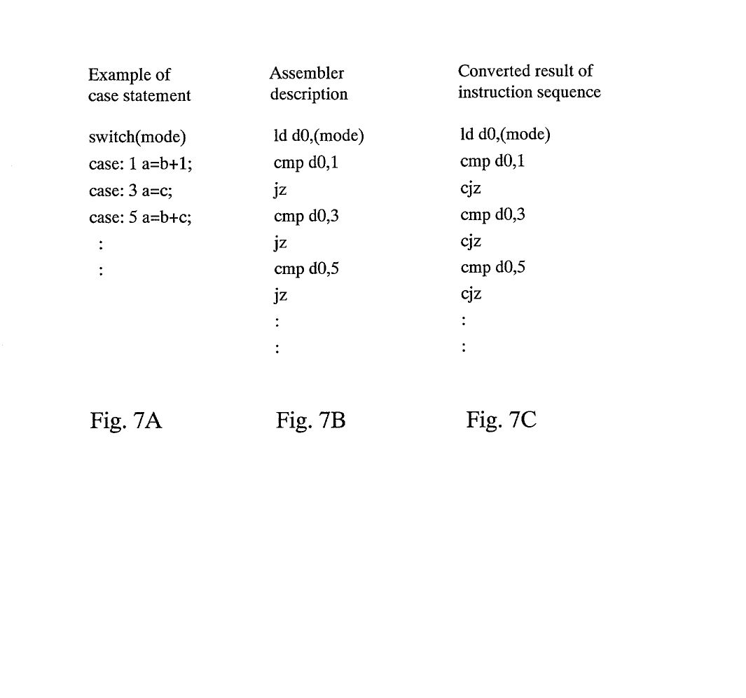

For example, if the branch is not approved in the limited conditional branch instruction, the instruction located next to the limited conditional branch instruction in the instruction sequence is checked. If it is a comparative instruction “cmp”, it can be detected that the limitation is satisfied. More specifically, a program written in case statement shown as FIG. 7(A) is compiled by the conventional compiler. FIG. 7(B) shows the compiled result which is written in assembler language. Then the compiled program written in assembler language is inputted to the instruction converter of the present invention, and an assembler instruction is extracted one by one through the instruction extraction step 500 and the extraction completion judgement step 501. The extracted instruction is judged as to whether it is a conditional branch instruction “jz” through the conditional branch instruction extraction step 502, and the instruction located next to the extracted instruction is judged as to whether it is a limited conditional branch instruction “cmp” through the limited instruction extraction step 503 and the limited judgement step 504. If the next instruction is judged as “cmp”, the conditional branch instruction “jz” is converted to the limited conditional branch instruction “cjz” through the limited conditional branch instruction converting step 505. By this processing, the conditional branch instruction “jz” shown in line 3, line 5 and line 7 are converted to the limited conditional branch instruction “cjz”. As a result of instruction converting, the converted instruction sequence shown as FIG. 7(C) is obtained.

As shown above, in the case that the instruction located next to the conditional branch instruction is a limited instruction, the conditional branch instruction is converted to the limited conditional branch instruction, then the converted instruction sequence can be obtained. The instruction converter of Embodiment 4 generates the instruction sequence used for the microprocessor of the present invention shown in Embodiment 1 to Embodiment 3.

Embodiment 5

The microprocessor of Embodiment 5 of the present invention will be described with reference to the accompanying drawing.

The microprocessor of Embodiment 5 is the one to prevent the branch penalty generation when the branch prediction that the branch is not approved is not hit. As for use of the limited conditional branch instruction, the microprocessor of Embodiment 5 is the same as Embodiment 1. However, in this Embodiment 5, the limited conditional branch instruction is one of the conditional branch instruction and the branch designation instruction to be executed in the case that the branch is approved is limited. When it is detected that the branch is approved as a result of decoding of the limited conditional branch instruction, the branch penalty can be prevented by conducting a fetch stage and a decode stage for the branch designation instruction within fewer machine cycles than required for conducting a fetch stage and a decode stage for normal instruction.

The microprocessor of Embodiment 5 includes a first memory for storing instructions and a second memory for storing op code of the branch designation instruction as a means for conducting a fetch stage and a decode stage for the branch designation instruction within the reduced machine cycles. When it is detected that the branch is approved as a result of decoding of the limited conditional branch instruction, the op code is provided from the dedicated register to the decoder and the operand is provided from the first memory to the decoder.

Particularly, in this Embodiment 5, a RAM is used as the first memory, and the dedicated register served as a high-speed memory that is dedicated for storing an op code of the instruction located at the branch designation. Because the dedicated register is used as the second memory in Embodiment 5, the op code of the branch designation to be executed next can be read quickly. In addition, because the dedicated register is a rewritable memory, the op code can be rewritten according to the necessity.

In the operation conducted in the microprocessor of Embodiment 1 to Embodiment 3, the calculation of the address of the branch designation is required by predecoding the limited conditional branch instruction at cycle 1. However, in the operation conducted in the microprocessor of Embodiment 5 to Embodiment 7, by limiting the kind of the instruction located at the branch designation, such pre-decoding is not required.

A schematic block diagram showing a configuration of an instruction fetch part, a memory, and an instruction register according to Embodiment 5 of the present invention is the same as FIG. 1. As mentioned above, the dedicated register 101 stores an op code of the branch designation instruction.

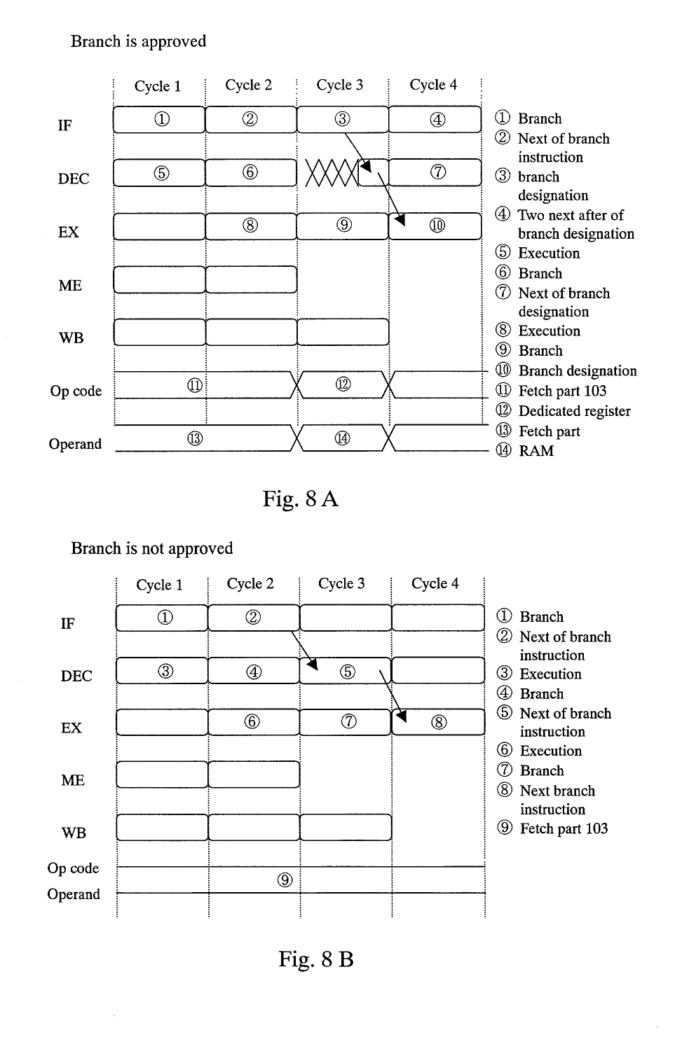

FIG. 8 is a timing chart showing an operation of a microprocessor according to Embodiment 5 of the present invention.

In FIG. 8, IF, DEC, EX, ME, and WB of the vertical axis mean each stage of a five-step pipeline respectively, and each IF, DEC, EX, ME and WB denotes the same shown in FIG. 2. The supply origins of the op code part and the operand part supplied to the instruction register 104 are shown under WB in FIG. 8.

FIG. 8(A) shows the operation when the branch prediction that the branch will not be approved is not hit and the branch is actually approved.

At cycle 1, the limit conditional branch instruction is fetched. In this case, the limited conditional branch instruction is stored in the fetch part 103.

Next, at cycle 2, the instruction located next to the limited conditional branch instruction is fetched in the fetch part 102 under the prediction that the branch will not be approved. In DEC stage, the limited conditional branch instruction is decoded, and it is detected that the branch is approved. Moreover, the branch designation address is calculated.

Next, at cycle 3, the op code of the branch designation instruction is supplied from the dedicated register 101 to the instruction register 104 and the operand is supplied from the memory 100 to the instruction register 104. The op code of the branch designation stored in the dedicated register 101 is limited, so the decode of the op code can be started immediately by supplying the op code from the dedicated register 101 to the instruction register 104. Moreover, even if the operand is supplied from the memory 100, the operand can be decoded within the period of cycle 3 because the decode operation of the operand is only selecting the register.

At the fetch stage of cycle 3, the branch designation instruction is fetched from the memory 100, at the same time, the instruction located next to the branch designation is fetched in the fetch part 102.

Next, at cycle 4, the instruction located next to the branch designation is decoded and the instruction located two instructions away from the branch designation instruction is fetched in the fetch part 102.

As shown above, when the branch prediction that the branch will not be approved is not hit, the branch penalty according to the branch processing is not generated.

FIG. 8(B) shows the operation when the branch prediction that the branch will not be approved is hit.

At cycle 1, the limit conditional branch instruction is fetched. In this case, the limited conditional branch instruction is stored in the fetch part 103. Moreover, the limited conditional branch instruction is pre-decoded and the branch designation address is calculated.

Next, at cycle 2, the instruction located next to the branch designation is fetched in the fetch part 102 under the prediction that the branch will not be approved. In DEC stage, the limited conditional branch instruction is decoded, and it is detected that the branch is not approved. Moreover, the branch designation address is calculated.

Next, at cycle 3, the instruction located two instructions away from the limited conditional branch instruction is fetched in the fetch part 102, and the instruction located next to the limited conditional branch instruction is decoded in the DEC stage.

As shown above, when the branch prediction that the branch will not be approved is hit, the branch penalty according to the branch processing is not generated.

According to the microprocessor of Embodiment 5, when the branch prediction that the branch will not be approved is not hit, the op code of the instruction of branch designation is supplied from the dedicated register to the decoder, and the operand of that instruction is also supplied from the memory to the decoder, and the decoded result is outputted to the execution stage. Therefore, the generation of the penalty can be prevented and the processing efficiency is improved and low power consumption is achieved.

Embodiment 6

The microprocessor of Embodiment 6 is the same configuration as that of Embodiment 5. In Embodiment 6, a dedicated ROM is used as the second memory, instead of the dedicated register used in Embodiment 5. The dedicated ROM is a ROM dedicated for storing an op code of the branch designation instruction.

In Embodiment 6, the dedicated ROM is used as the second memory, the op code of the branch designation instruction can be read quickly. In addition, the manufacturing cost will be decreased compared to the case in which the dedicated register is used.

The configuration of Embodiment 6 is the same as that of FIG. 3 of Embodiment 2. In the configuration shown in Embodiment 5 (it is the same as that of FIG. 1), the second memory is the dedicated register 101. However, in the configuration of Embodiment 6, the second memory is the dedicated ROM 101a instead. This dedicated ROM 101a stores the op code of the instruction that is located at the branch designation of the limited conditional branch instruction—the op code that will be executed if the branch condition is approved. For example, the op code of the instruction such as “cmp” is stored in the dedicated ROM 101a as the limited instruction. Because the op code of such predetermined instruction is prepared in advance, such op code of the instruction that is located at the branch designation of such limited conditional branch instruction can be provided quickly.

Other elements, such as the RAM 100 as the first memory, the fetch part 102, the fetch part 103, the instruction register 104, the selection 105, and the selection control signal 106 are the same as that of FIG. 3, so the explanation for them will be omitted here.

According to the microprocessor of Embodiment 6, the second memory is the dedicated ROM. The op code that is located at the branch designation of the limited conditional branch instruction can be read quickly, and the manufacturing cost will be decreased compared to the case in which the dedicated register is used. In Embodiment 5, the second memory is the dedicated register, so the initialization process for the dedicated register should be described in the initialization routine process executed at the boot up processing. However, in Embodiment 6, the second memory is the dedicated ROM, so the initialization process for the dedicated ROM is not necessary and the initialization routine process is not necessary to be described.

Embodiment 7

The microprocessor of Embodiment 7 of the present invention will be described with reference to the accompanying drawing.

The same as Embodiment 5 and Embodiment 6, the microprocessor of Embodiment 5 is the one to prevent the generation of the branch penalty when the branch prediction that the branch is not approved is not hit. Moreover, the same as Embodiment 5 and Embodiment 6, the limited conditional branch instruction is used in the microprocessor of this Embodiment 7.

The microprocessor of Embodiment 7 includes a first decoder for decoding normal instructions and a second decoder that is a dedicated decoder for decoding a branch designation instruction within fewer machine cycles than required for decoding general instructions as a means for conducting a fetch stage and a decode stage for the following instruction within the small machine cycles. In the DEC stage, normally, the first decoder is used. If the instruction to be processed is the limited conditional branch instruction, at first, the first decoder decodes it and it is detected that the branch is approved, then the second decoder is used in the next DEC stage of the branch designation instruction within the small machine cycles.

A schematic block diagram showing a configuration of an instruction fetch part, a memory, and an instruction register according to Embodiment 7 of the present invention is the same as FIG. 4.

In Embodiment 7, the first decoder is provided as a basic decoder for conducting the DEC stage of the general instructions, and furthermore, the second decoder is provided as a dedicated decoder for conducting the DEC stage of the branch designation instruction. The second decoder has a dedicated module for decoding the specified limited instruction, so the hardware scale is compact and the decode time is short. By this arrangement, in the case that the branch prediction is not hit, the DEC stage for the branch designation instruction can be conducted within fewer machine cycles than required for decoding the normal instructions. Therefore, the generation of the branch penalty can be prevented.

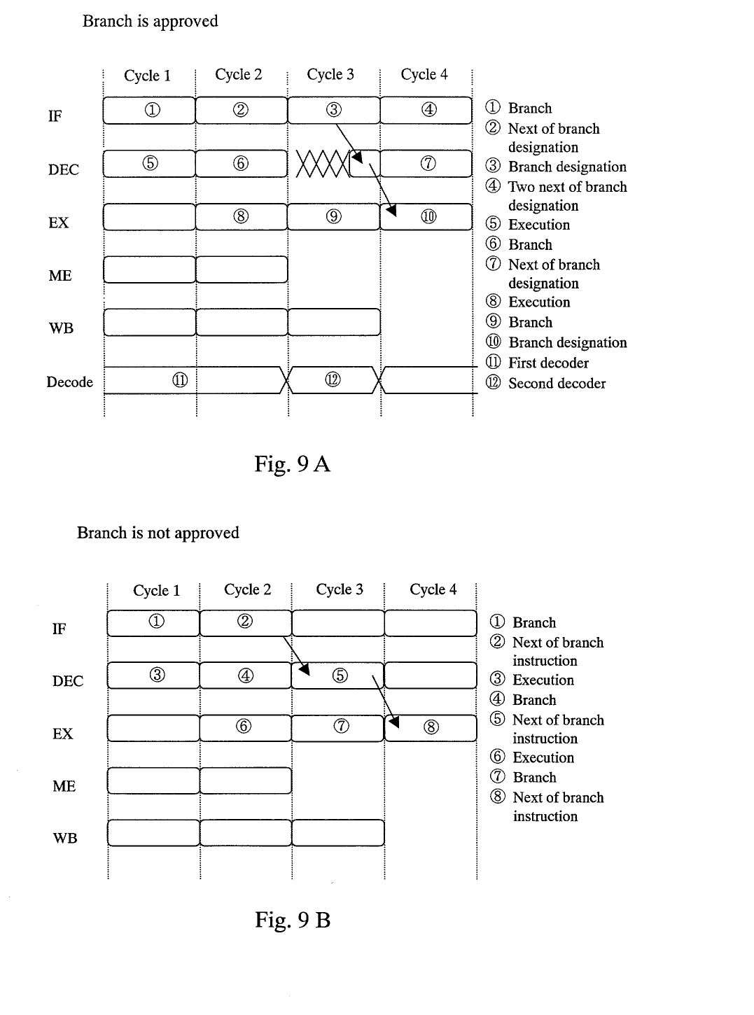

FIG. 9 is a timing chart showing an operation of a microprocessor according to Embodiment 7 of the present invention.

In FIG. 9, the same as FIG. 5, IF, DEC, EX, ME, and WB of the vertical axis mean each stage of a five-step pipeline respectively. In FIG. 9(A), the decoder to be used is shown under WB.

FIG. 9(A) shows the operation when the branch prediction that the branch will not be approved is not hit and the branch is actually approved.

First, at the cycle 1, a limited conditional branch instruction is fetched from the fetch part 103.

Next, at the cycle 2, the instruction located next to the limited conditional branch instruction is fetched in the fetch part 102 under the branch prediction that the branch will not be approved. Moreover, the limited conditional branch instruction is decoded by the first decoder 301 and it is detected that the branch is approved and the address of the branch designation is calculated.

Next, at the cycle 3, it has already been detected that the branch prediction is not approved in the DEC stage of the cycle 2, so the second decoder 302 is used. In this case, the branch designation instruction is provided from the memory 100 to the instruction register 300, and the instruction stored in the instruction register 300 and the decoder selection signal 303 are provided to the second decoder 302 and the provided instruction is decoded. Herein, the branch designation instruction is limited, and the second decoder 302 is the dedicated decoder having the dedicated module to decode such limited instruction, and the second decoder 302 can decode such limited instruction in a short period. Moreover, the instruction located two instructions away from the branch designation instruction is fetched in the fetch part 102.

Next, at the cycle 4, the output of the decoder 302 is selected by the selection part 305 and 307 and provided to the EX stage. Moreover, the DEC stage of the instruction at the next of the branch designation is conducted, the first decoder 301 conducts the DEC stage by using the output signal of the second decoder 302 and the instruction register 300. Moreover, the IF stage of the instruction located two instructions away from the branch designation is fetched in the fetch part 103.

Although not shown in FIG. 9, after the cycle 4, the selection part 307 and the selection part 305 selects the output of the first decoder 302 until the next limited conditional branch instruction is coming.

As shown above in the microprocessor of Embodiment 7, in the case that the branch prediction that branch will not be approved is not hit, the branch penalty is not generated.

FIG. 9(B) shows the operation when the branch prediction that the branch will not be approved is hit. All DEC stage are conducted by the first decoder 301.

First, at the cycle 1, a limited conditional branch instruction is fetched from the fetch part 103.

Next, at the cycle 2, the instruction located next to the limited conditional branch instruction is fetched in the fetch part 102 under the branch prediction that the branch will not be approved. Moreover, the limited conditional branch instruction is decoded by the first decoder 301 and it is detected that the branch is approved. Moreover, the address of the branch designation is calculated.

Next, at the cycle 3, the instruction located two instructions away from the limited conditional branch instruction is fetched in the fetch part 102, and the instruction located next to the limited conditional branch instruction is decoded by the first decoder 301.

As shown above, in the case that the branch prediction is hit, the branch penalty is not generated.

According to the microprocessor of Embodiment 7 of the present invention, in the case that the branch prediction that the branch will not be approved is not hit, the branch designation instruction is limited, and the second decoder is a dedicated decoder having the dedicated module to decode such limited instruction, so the second decoder can decode such limited instruction in a short period. As a result, IF stage and DEC stage for the branch designation instruction can be conducted within machine cycles corresponding to the machine cycles for the EX stage of the limited conditional branch instruction. Therefore, the branch penalty generation can be prevented and the processing efficiency is improved and low power consumption is achieved.

Embodiment 8

An instruction converter of the Embodiment 8 of the present invention is shown.

The instruction converter of Embodiment 8 generates the instruction sequence used for the microprocessor shown in Embodiment 5 to Embodiment 7. The instruction converter of the present invention inputs the compiled instruction sequence compiled by the conventional compiler, and detects a conditional branch instruction which can be converted to a limited conditional branch instruction used in a microprocessor of the present invention, and converts the conditional branch instruction into the limited conditional branch instruction for the microprocessor of the present invention.

The instruction converter of Embodiment 8 generates the instruction sequence used for the microprocessor shown in Embodiment 5 to Embodiment 7 operated with the branch prediction that the branch will not be approved. In this case, a conditional branch instruction whose branch designation instruction is limited is determined as a limited conditional branch instruction. When the instruction converter of the present invention detects a conditional branch instruction in the inputted instructions, checks the branch designation instruction in the case that the branch is approved, and checks if the relationship of the conditional branch instruction and the branch designation instruction corresponds to the relationship of the limited conditional branch instruction and the branch designation instruction, and if it corresponds, the conditional branch instruction is converted to the limited conditional branch instruction.

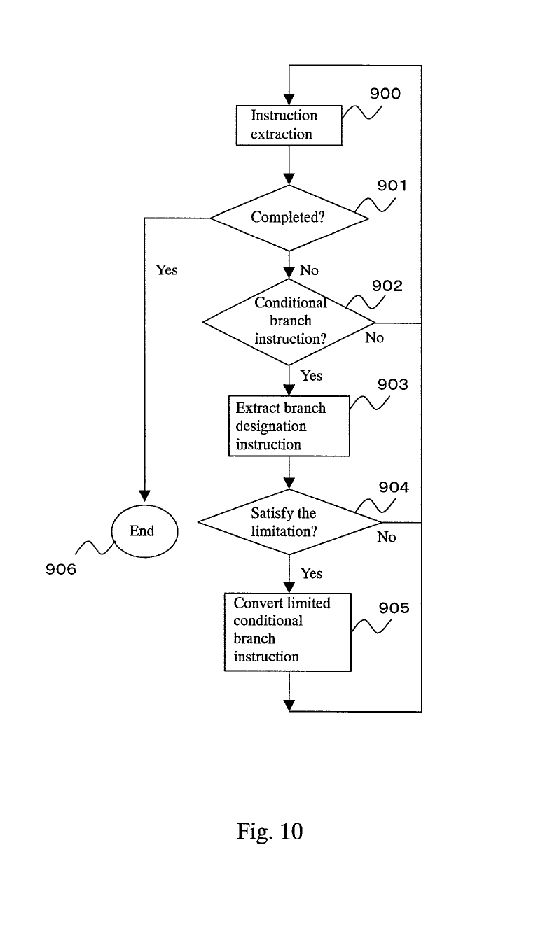

FIG. 10 is a flowchart showing instruction converting steps in the instruction converter according to Embodiment 8 of the present invention.

In FIG. 10, 900 denotes an instruction extraction step for extracting an instruction written in the assembler language one by one from the inputted compiled instruction. 901 denotes an extraction completion judgement step for judging whether or not all the instructions are extracted. 902 denotes a conditional branch instruction extraction step for judging whether or not the extracted instruction is the conditional branch instruction. 903 denotes a limited instruction extraction step for extracting the branch designation instruction when the conditional branch instruction is extracted in the step 903. 904 denotes a limitation judgement step for judging whether or not the extracted branch designation instruction is the limited conditional branch instruction at step 903. 905 denotes a limited conditional branch instruction converting step for converting the conditional branch instruction extracted at step 900 to the limited conditional branch instruction when it is detected that the instruction extracted at step 903 satisfies the limitation at the limitation judgement step 904. 906 denotes an end step for ending the instruction converting processing.

The instruction converting operation in the instruction converter of the present invention is described with an example.

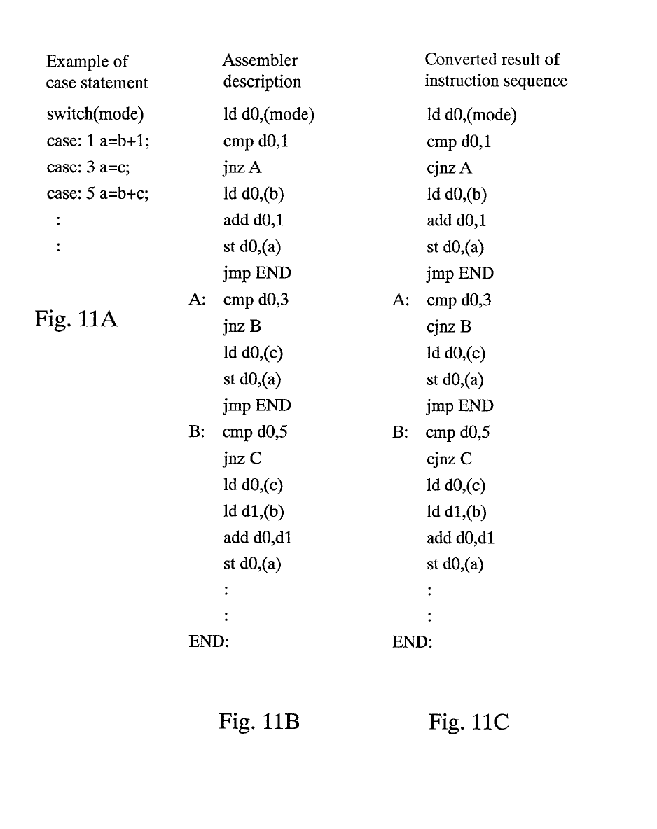

For example, the branch designation instruction is limited as a comparative instruction “cmp”, if the branch is approved in the limited conditional branch instruction. For example, a program written in case statement shown as FIG. 11(A) is compiled by the conventional compiler, and the compiled result written in assembler language shown in FIG. 7(B) is obtained. The case statement program shown in FIG. 11(A) is the same as the case statement program shown in FIG. 6(A), but in this case, the compile rule employed in the compiler is different, so the compiled result shown in FIG. 11(B) is different from the compiled result shown in FIG. 7(B). In FIG. 7(B), the conditional branch instruction “jz” that branches when the comparing result matches is used, but in FIG. 11(B), the conditional branch instruction “jnz” that branches when the comparing result does not match is used. Because of this difference, in most cases in FIG. 7(B), the comparative instruction “cmp” is placed immediately after the conditional branch instruction “jz”, but in FIG. 11(B), in most cases, the comparative instruction “cmp” is placed at the branch designation of the conditional branch instruction “jnz” on the contrary. In other words, FIG. 11(B) shows the case that the branch designation instruction of the conditional branch instruction is limited to the comparative instruction “cmp”.

Then the compiled program written in assembler language is inputted to the instruction converter of Embodiment 8 of the present invention, an assembler instruction is extracted one by one through the instruction extraction step 900 and the extraction completion judgement step 901. The extracted instruction is judged as to whether it is a conditional branch instruction “jnz” through the conditional branch instruction extraction step 902, and the extracted branch designation instruction is judged as to whether it is “cmp” through the limited instruction extraction step 903 and the limitation judgement step 904. If the extracted branch designation instruction is judged as “cmp”, the conditional branch instruction “jnz” is converted to the limited conditional branch instruction “cjnz”. By this processing, the conditional branch instruction “jnz” shown in line 3, line 9 and line 14 are converted to the limited conditional branch instruction “cjnz”. As a result of instruction converting, the converted instruction sequence shown as FIG. 11(C) is obtained.

As shown above, in the case that the branch designation instruction of the conditional branch instruction is a limited instruction, the conditional branch instruction is converted to the limited conditional branch instruction, then the converted instruction sequence can be obtained. The instruction converter of Embodiment 8 converts the compiled program compiled by the conventional compiler to the instruction sequence used for the microprocessor shown in Embodiment 5 to Embodiment 7.

Embodiment 9

Hereinafter, the present invention of the microprocessor of Embodiment 9 will be described with reference to the accompanying drawing.

The microprocessor of Embodiment 9 is the one using the limited unconditional branch instruction.

Regarding the program written by the case statement, when the branch instruction is executed, unconditional branch instructions such as “jmp” instruction are often found both in the branch designation processing when the branch condition is approved and in the following processing of the branch processing when the branch condition is not approved. In addition, a load instruction “lD” is often put at the branch designation of the unconditional branch instruction. The microprocessor in Embodiment 9 utilizes this characteristic and employs the limited unconditional branch instruction in order to improve processing speed. Herein, a limited unconditional branch instruction is a type of the unconditional branch instruction whose instruction located at the branch designation is limited. When the limited unconditional branch instruction is detected as a result of decoding, the generation of the branch penalty can be prevented by conducting a fetch stage and a decode stage for the instruction located at the branch designation quickly within fewer machine cycles than required for conducting a fetch stage and a decode stage for a normal instruction.

The microprocessor of Embodiment 9 includes a first memory for storing instructions and a second memory for storing the op code of the instruction located at the branch designation of the limited unconditional branch instruction as a means for conducting a fetch stage and a decode stage of within few machine cycles. When the limited unconditional branch instruction is detected as a result of decoding, the op code is provided from the second memory to the decoder quickly and the operand is provided from the first memory to the decoder quickly.

Particularly, in Embodiment 9, a dedicated register serves as a high-speed memory that is dedicated to storing the op code of the branch designation instruction. Because the dedicated register is used as the second memory in Embodiment 9, the stored op code to be executed next can be read quickly. In addition, because the dedicated register is a rewritable memory, the op code can be rewritten according to the necessity.

The microprocessor shown in the following example employs the limited conditional branch instruction shown in Embodiment 5, in addition to the above-mentioned limited unconditional branch instruction. The microprocessor shown in Embodiment 9, regarding the limited conditional branch instruction, is the same as Embodiment 5, the branch penalty is prevented even when the branch prediction that branch will not be approved is not actually hit. Regarding the limited unconditional branch instruction, the processing speed is improved by utilizing above-mentioned characteristics.

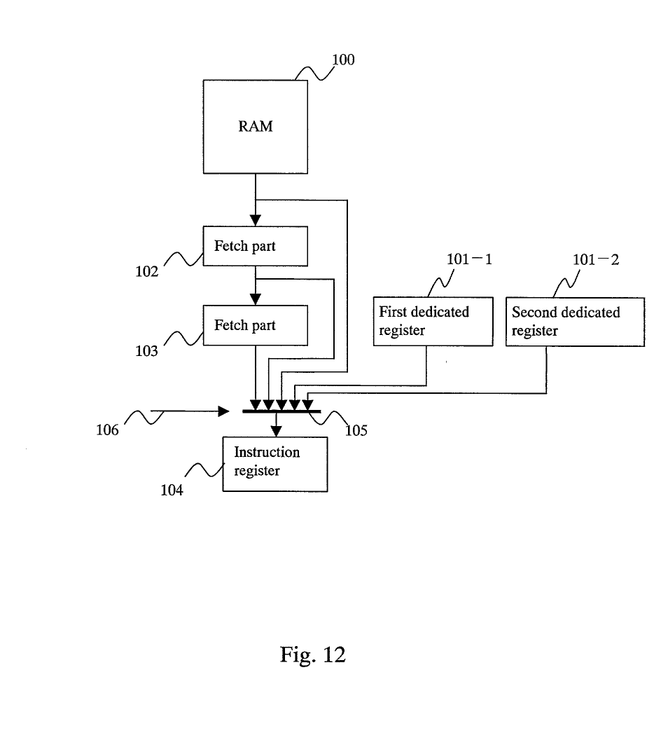

FIG. 12 is a schematic block diagram showing a configuration of the microprocessor of Embodiment 9.

In FIG. 12, 100 denotes a RAM as a first memory storing instructions, 101 denotes two dedicated registers as second memories. In Embodiment 9, the following 2 dedicated registers are included.

A first dedicated register 101-1 denotes a dedicated register storing the op code of the instruction located at the branch designation of the limited conditional branch instruction. The first dedicated register will be used when the branch prediction that the branch condition is not approved is not actually hit.

A second dedicated register 101-2 denotes a dedicated register for the limited unconditional branch instruction storing the op code of the instruction which is located at branch designation of the limited unconditional branch instruction.

These dedicated register 101-1 and 101-2 serve as high-speed memories. For example, the op code of the instruction such as “cmp” is stored in the dedicated register 101-1 as the limited instruction and the op code of the instruction such as load instruction “lD” is stored in the dedicated register 101-2 as the limited instruction. Because the op codes of such predetermined instruction are prepared in advance, such op codes of the limited instructions can be provided quickly.

Other elements, such as the fetch part 102, the fetch part 103, the instruction register 104, the selection 105, and the selection control signal 106 are the same as that of FIG. 1, so the explanation for them will be omitted here.

Herein, the selection part 105 selects and outputs a value from one of the following : the RAM 100, the fetch part 102, fetch part 103, the first dedicated register 101-1 and the second dedicated register 101-2. The selection control signal 106 indicates which value should be selected from among those 5 values.

According to the microprocessor of Embodiment 9, the same as Embodiment 5, even when the conditional branch of the limited conditional branch instruction is actually approved and the branch prediction is not actually hit, the fetch and decode for the branch designation instruction can be conducted in one cycle, and the branch penalty can be prevented. Moreover, when the limited unconditional branch instruction is executed, the op code of the branch designation which is prepared in advance is provided from the dedicated register 101-2 of the second memory to the instruction register 104 through the selection part 105, and the operand is provided from the RAM 100 of the first memory to the instruction register 104 through the selection part 105. The fetch and the decode of the limited unconditional branch instruction can be conducted in one cycle, and the processing speed can be improved.

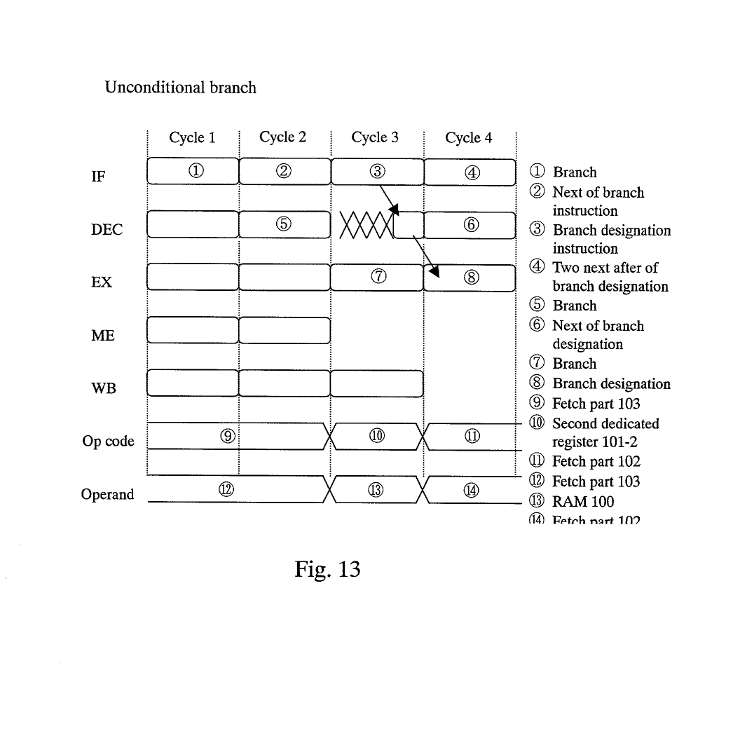

FIG. 13 is a timing chart showing an operation of the limited unconditional branch instruction of a microprocessor according to Embodiment 9 of the present invention. Here, the timing chart shows an operation of the limited conditional branch instruction and is the same as that of FIG. 8 of Embodiment 5, so the description about it is omitted in this Embodiment 9.

In FIG. 13, IF, DEC, EX, ME, and WB of the vertical axis represent each stage of a five-step pipeline, respectively: IF denotes the instruction fetch stage: DEC denotes the decode stage: EX denotes the execution stage: ME denotes the memory access stage: and WB denotes the write back stage. These describe four cycles. Moreover, the supply origins of the op code part and the operand part supplied to the instruction register 104 are shown under WB in FIG. 13.

At cycle 1, the limit unconditional branch instruction is fetched. In this case, the limited unconditional branch instruction is stored in the fetch part 103.

Next, at cycle 2, the instruction located next to the limited unconditional branch instruction is fetched in the fetch part 102. In DEC stage, the limited unconditional branch instruction is decoded, and it is detected that the unconditional branch is approved.

In this case, it is known in advance that the limited unconditional branch instruction always branches, so the judging process whether the branch condition is actually approved or not is not necessary.

Next, at cycle 3, the op code is provided from the dedicated register 101-2 of the second memory as the op code of the branch designation instruction, and the operand is provided from the RAM 100 of the first memory to the instruction register 104. Here, the kind of the op code of the branch designation instruction of the limited unconditional branch instruction is limited (for example, “lD”) in order to match the op code stored in the second dedicated register 101-2, so the decode stage can be started quickly by providing the op code from the second dedicated register 101-2 to the instruction register 104. Moreover, the decode for the operand is executed only by selecting the register, so the decode for the operand can be conducted quickly within cycle 3.

In the fetch stage of the cycle 3, the operand of the branch designation instruction is read from the RAM 100, and the subsequent instruction is fetched in the fetch part 102 at the same time.

Next, at the cycle 4, the instruction located two instructions away from the branch designation instruction is fetched in the fetch part 102, and the instruction located next to the branch designation instruction is decoded in the DEC stage.

As shown above, the processing speed of the limited unconditional branch instruction can be improved.

According to the microprocessor of Embodiment 9, the branch designation instruction of the limited unconditional branch instruction is limited, so the fetch and decode stages for the branch designation instruction can be conducted within fewer machine cycles than required for fetching and decoding the general instructions. Therefore, the processing efficiency can be improved and low power consumption can be achieved.

Embodiment 10

The microprocessor of Embodiment 10 is the same configuration as that of Embodiment 9. In Embodiment 10, a first dedicated ROM and a second dedicated ROM are used as the second memory instead of the first dedicated register and the second dedicated register used in Embodiment 9.

The same as Embodiment 6, the first dedicated ROM is a ROM dedicated for storing the op code of the instruction located at the branch designation of the limited conditional branch instruction. The first dedicated ROM will be used when the branch prediction that the branch condition is not approved is not actually hit. The second dedicated ROM is a ROM dedicated for storing the op code of the instruction located at the branch designation of the limited unconditional branch instruction.

In Embodiment 10, the dedicated ROMs are used as the second memories, and the op codes can be read quickly. In addition, the manufacturing cost will be decreased compared to the case in which the dedicated registers are used.

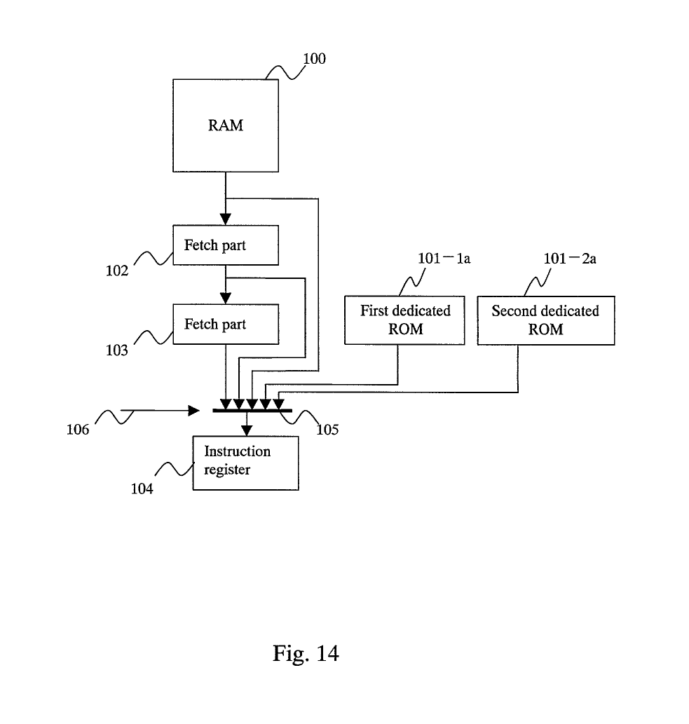

FIG. 14 is a diagram showing the configuration of the microprocessor of Embodiment 10. In the configuration of Embodiment 9 shown in FIG. 12, the second memories are the first dedicated register 101-1 and the second dedicated register 101-2. However, in the configuration of Embodiment 10 shown in FIG. 14, the second memories are the first dedicated ROM 101-1a and the second dedicated ROM 101-2a. These dedicated ROM 101-1a and 101-2a serve as high-speed memories. For example, this first dedicated ROM 101-1a stores the op code of the limited instruction such as a compare instruction “cmp”, the second dedicated ROM 101-2a stores the op code of the limited instruction such as a load instruction “lD”. Because the op codes of such predetermined instructions are prepared in advance, such op codes can be provided quickly.

Other elements, such as the RAM 100 as the first memory, the fetch part 102, the fetch part 103, the instruction register 104, the selection 105, and the selection control signal 106 are the same as that of FIG. 12, so the explanation for them will be omitted here.

Herein, the selection part 105 selects and outputs a value from on of the following: the RAM 100, the fetch part 102, fetch part 103, the first dedicated ROM 10125 1a, and the second dedicated ROM 101-2a. The selection control signal 106 indicates which value should be selected among those 5 values.

According to the microprocessor of Embodiment 10, the second memories are the dedicated ROMs, the op code of the instruction located at the branch designation of the limited conditional branch instruction and the op code of the instruction located at the branch designation of the limited unconditional branch instruction can be read quickly, and the manufacturing cost will be decreased compared to the case in which the dedicated registers are used. In Embodiment 9, the second memories are the dedicated registers, so the initialization process for the dedicated register should be described in the initialization routine process executed at the boot up processing. However, in Embodiment 10, the second memories are the dedicated ROMs, so the initialization process for the dedicated ROM is not necessary and the initialization routine process is not necessary to be described in the boot up processing.

Embodiment 11

The microprocessor of Embodiment 11 of the present invention will be described with reference to the accompanying drawing. As in Embodiment 9, the microprocessor of Embodiment 11 utilizes the limited unconditional branch instruction. The microprocessor of Embodiment 11 includes a first decoder used for decoding general instructions and a second decoder used for decoding instruction located at the branch designation of the limited unconditional branch instruction, and it can decode the instruction within fewer machine cycles than required for decoding general instructions. In the DEC stage, as a basic decoder, the first decoder is used. When the first decoder decodes the limited unconditional branch instruction, then the second decoder is used for decoding the limited unconditional branch instruction in a short time.

The figure showing the fetch part, the memory, and the instruction register of Embodiment 11 is the same as FIG. 4, so the explanation for them will be omitted here.

In Embodiment 11, the first decoder 301 is a main decoder used in the DEC stage, and the second decoder 302 is a dedicated decoder for decoding the branch designation instruction of the limited unconditional branch instruction. The hardware scale of the second decoder 302 is small, so the decoding period is short enough to finish decoding the branch designation instruction within fewer machine cycles than required for a normal instruction.

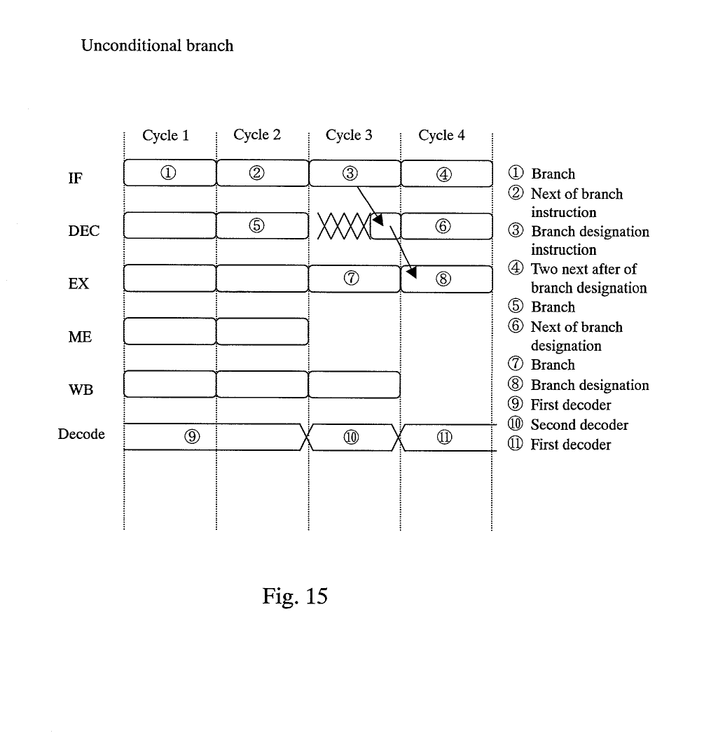

FIG. 15 is a timing chart showing an operation of a microprocessor according to Embodiment 11 of the present invention. In FIG. 15, as in FIG. 9 described in Embodiment 7, IF, DEC, EX, ME, and WB of the vertical axis represent each stage of a five-step pipeline respectively. In FIG. 15, the decoder to be used is shown under WB.

First, at cycle 1, a limited unconditional branch instruction is fetched from the fetch part 103.

Next, at cycle 2, the instruction located at the limited unconditional branch instruction is fetched in the fetch part 102. Moreover, the limited unconditional branch instruction is decoded by the first decoder 301 and it is detected that the unconditional branch is approved. In this case, it is known in advance that the limited unconditional branch instruction always branches, so the judging process whether the branch condition is actually approved or not is not necessary.

Next, at cycle 3, the limited unconditional branch instruction is detected at the decode stage in cycle 2, and the branch designation instruction is decoded by the second decoder 302. The branch designation instruction is provided from the memory 100 to the instruction register 300, and the value of the instruction register 300 and the decoder selection signal 303 are provided to the second decoder, and the branch designation instruction is decoded. Herein, kind of the branch designation instruction is limited (for example, “lD”), and the second decoder 302 is a dedicated module for decoding such limited kind of instruction, so it can be decoded within short period. Moreover, at cycle 3, the instruction located two instructions away from the branch designation instruction is fetched to the fetch part 102.

Next, at cycle 4, the output of the decoder 302 is selected by the selection part 305 and 307 and provided to the EX stage. In the DEC stage, the instruction located next to the branch designation instruction is decoded, and the first decoder 301 conducts the DEC stage by using the output signal of the second decoder 302 and the instruction register 300. Moreover, in the IF stage, the instruction located two instructions away from the branch designation instruction is fetched to the fetch part 103.

Although not shown in FIG. 15, after cycle 4, the selection part 307 and the selection part 305 select the output of the first decoder 302.

As shown above, according to the microprocessor of the Embodiment 11, the branch designation instruction of the limited unconditional branch instruction is limited, and the second decoder dedicated for decoding the branch designation instruction is used in the DEC stage for decoding such branch designation instruction. The second decoder can decode it within a short period and output the decode result to the EX stage, so the instruction located at the branch designation of the limit unconditional branch instruction can be executed quickly. The processing efficiency is improved and low power consumption is achieved.

Embodiment 12

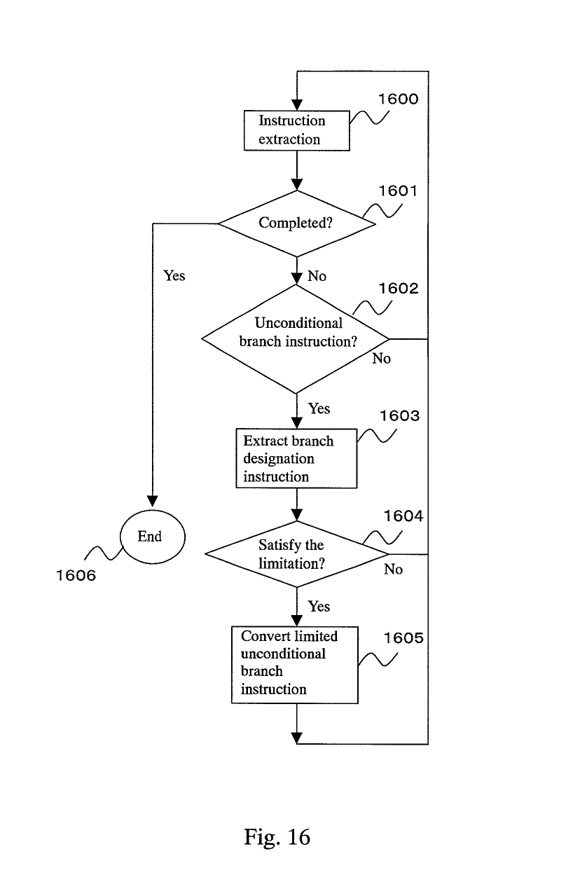

An instruction converter of Embodiment 12 of the present invention is shown in FIG. 16. The instruction converter of Embodiment 12 generates the instruction sequence used for the microprocessor of the present invention shown in Embodiment 9 to Embodiment 11. The instruction converter of the present invention inputs the compiled instruction sequence compiled by the conventional compiler, and detects unconditional branch instruction that can be converted to a limited unconditional branch instruction used in a microprocessor of the present invention. The converter converts the unconditional branch instruction into the limited unconditional branch instruction for the microprocessor of the present invention.

The instruction converter of Embodiment 12 converts the unconditional branch instruction whose branch designation instruction is limited to the limited unconditional branch instruction. The instruction converter of the present invention detects an unconditional branch instruction in the inputted instructions, and checks to see if the relationship of the branch designation instruction and the unconditional branch instruction corresponds to the relationship of the branch designation instruction and the limited unconditional branch instruction. If so, the unconditional branch instruction is converted to the limited unconditional branch instruction.

FIG. 16 is a flowchart showing instruction converting steps in the instruction converter according to Embodiment 12 of the present invention. In FIG. 16, 1600 denotes an instruction extraction step for extracting an assembler language one by one from the inputted compiled instruction. 1601 denotes an extraction completion judgement step for judging whether all the instructions are extracted. 1602 denotes an unconditional branch instruction extraction step for judging whether the extracted instruction is the unconditional branch instruction. 1603 denotes a branch designation instruction extraction step for extracting the branch designation instruction when the unconditional branch instruction is extracted. 1604 denotes a limitation judgement step for judging whether or not the extracted branch designation instruction at step 1603 is the limited unconditional branch instruction. 1605 denotes a limited unconditional branch instruction converting step for converting the unconditional branch instruction extracted at step 1600 to the limited unconditional branch instruction when it is detected that the branch designation instruction satisfies the limitation at the limitation judgement step 1604. 1606 denotes an end step for ending the instruction converting processing.

The above-mentioned flowchart only shows the converting step to the limited unconditional branch instruction, however, the converting step to the limited conditional branch instruction shown in Embodiment 4 or Embodiment 8 can be employed as well.

The instruction converting operation in the instruction converter of the present invention is described with an example. In this example, the converting step to the limited conditional branch instruction shown in Embodiment 4 or Embodiment 8 are employed simultaneously.

For example, regarding the converting step to the limited unconditional branch instruction, if the branch designation instruction of the unconditional branch instruction “jmp” is a load instruction “lD”, it can be detected that the limitation as a limited unconditional branch instruction is satisfied. Regarding the converting step to the limited conditional branch instruction, for example, as in Embodiment 4, if the instruction located next to the conditional branch instruction “jnz” is a comparative instruction “cmp”, it can be detected that the limitation as a limited conditional branch instruction is satisfied.

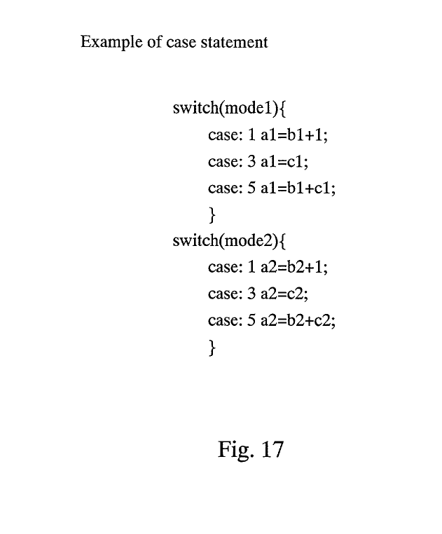

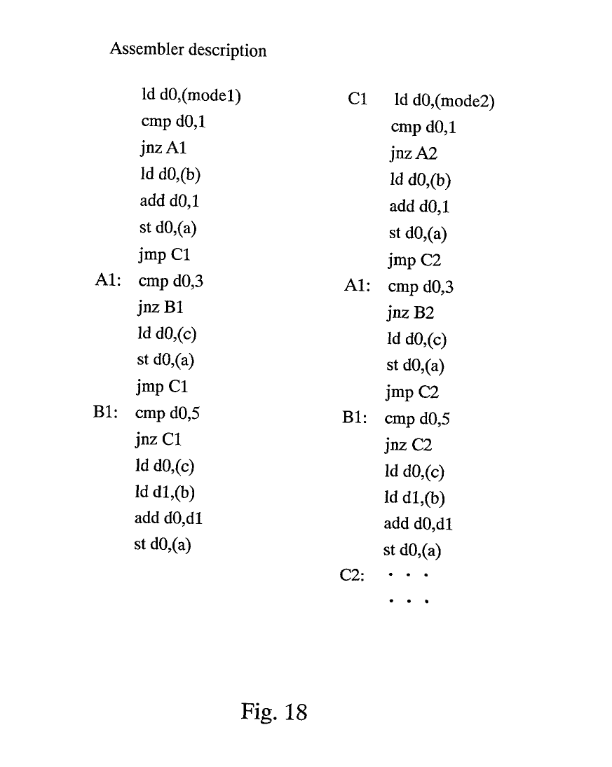

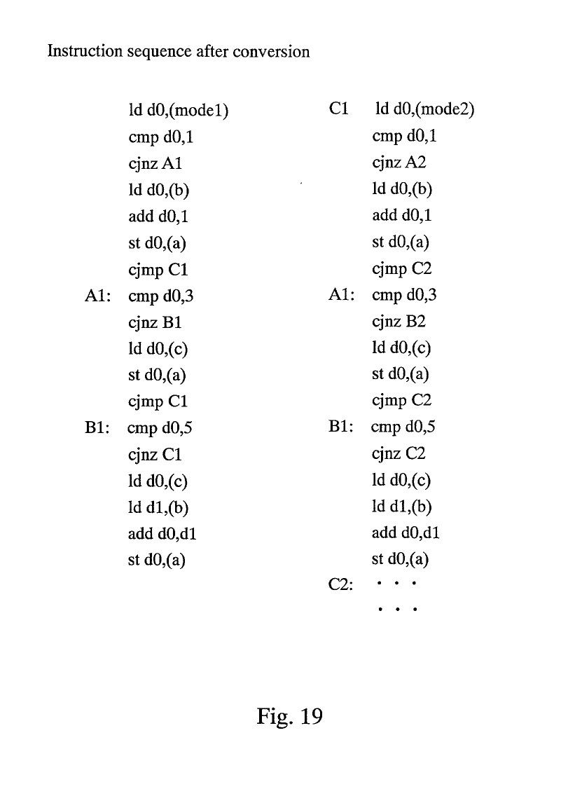

First, a program written in case statement shown as FIG. 17 is compiled by the conventional compiler. FIG. 18 shows the compiled result which is written in assembler language. Then the compiled program written in assembler language is inputted to the instruction converter of the present invention, an assembler instruction is extracted one by one through the instruction extraction step 1500 and the extraction completion judgement step 1501. The extracted instruction is judged whether it is an unconditional branch instruction “jmp C1” through the unconditional branch instruction extraction step 1502, and the branch designation instruction is judged whether it is a limited unconditional branch instruction “lD” through the branch designation instruction extraction step 1503 and the limited judgement step 1504. If the branch designation instruction is judged as “lD”, the unconditional branch instruction “jmp C1” is converted to the limited unconditional branch instruction “cjmp C1” through the limited unconditional branch instruction converting step 1505. By this processing, these unconditional branch instructions “jmp C1” shown in line 7 and line 12 in the left column of FIG. 18 are converted to the limited unconditional branch instructions “cjmp C1” as shown in the left column of FIG. 19. In the same way, these unconditional branch instructions “jmp C2” shown in line 7 and line 12 in the right column of FIG. 18 are converted to the limited unconditional branch instructions “cjmp C2” as shown in the right column of FIG. 19.

Next, regarding the converting step to the limited conditional branch instruction, for example, as in FIG. 4, by the conversion processing of steps 501 to 505, the conditional branch instructions “jnz A1” shown in line 3 in the left column of FIG. 18, “jnz B1” shown in line 9 in the left column of FIG. 18, and “jnz C1” shown in line 14 in the left column of FIG. 18 are converted to the limited conditional branch instruction “cjnz A1” shown in line 3 in the left column of FIG. 19, “cjnz B1” shown in line 9 in the left column of FIG. 19, and “cjnz C1” shown in line 14 in the left column of FIG. 19, respectively. In the same way, the conditional branch instructions “jnz A2” shown in line 3 in the right column of FIG. 18, “jnz B2” shown in line 9 in the right column of FIG. 18, and “jnz C2” shown in line 14 in the right column of FIG. 18 are converted to the limited conditional branch instructions “cjnz A2” shown in line 3 in the right column of FIG. 19, “cjnz B2” shown in line 9 in the right column of FIG. 19, and “cjnz C2” shown in line 14 in the right column of FIG. 19, respectively. As a result of instruction conversion, the converted instruction sequence shown as FIG. 19 is obtained.

As shown above, when the branch designation instruction of the unconditional branch instruction is a limited instruction, the unconditional branch instruction is converted to the limited unconditional branch instruction, and the converted instruction sequence can be obtained. The instruction converter of Embodiment 12 generates the instruction sequence used for the microprocessor of the present invention shown in Embodiment 9 to Embodiment 11.

In Embodiment 1, Embodiment 5 and Embodiment 9, only one particular instruction such as comparative instruction “cmp” is stored in the dedicated register, but plural particular instructions can be prepared according to each case statement respectively, and respective instruction can be re-stored in the dedicated register according to the processed case statement.

Moreover, in the above mentioned Embodiment, the length of the op code is assumed as fixed length, but it can be a variable length by setting a field for defining the length of the op code in the dedicated register.

Moreover, in the above-mentioned Embodiments 1, 2, 5, 6, 9 and 10, it is assumed that only one dedicated register and one dedicated ROM are included in the configuration. However, when there are more than one of the limited conditional branch instructions or more than one limited unconditional branch instructions, more than one of the dedicated registers and dedicated ROM can be included in the configuration, correspondingly.

Moreover, in Embodiment 3, Embodiment 7 and Embodiment 11, it is assumed that the dedicated second decoder can decode only one particular instruction such as “cmp”, but it can decode several instructions at high speed.

The invention may be embodied in other forms without departing from the spirit or essential characteristics thereof. The embodiments disclosed in this application are to be considered in all respects as illustrative and not limitative, the scope of the invention is indicated by the appended claims rather than by the foregoing description, and all changes which come within the meaning and range of equivalency of the claims are intended to be embraced therein.

What is claimed is:

1. A microprocessor having a branch prediction that the branch will be approved,
employing a limited conditional branch instruction whose instruction to be executed next when the branch prediction is not hit is limited;
wherein, if it is detected that the branch is not approved in decode stage for the limited conditional branch instruction, a fetch stage and a decode stage for the next instruction to be executed are conducted in fewer machine cycles than required for a fetch stage and a decode stage for a normal instruction.

2. A microprocessor having a branch prediction that the branch will be approved,
employing a limited conditional branch instruction whose next instruction to be executed next when the branch prediction is not hit is limited, comprising:
a first memory for storing instructions;
a second memory for storing an op code of the instruction to be executed next when the branch prediction is not hit;
wherein, if it is detected that the branch is not approved in the decode stage for the limited conditional branch instruction, an op code is provided from the second memory to the decoder and an operand is provided from the first memory to the decoder.

3. A microprocessor having a branch prediction that the branch will be approved,
employing a limited conditional branch instruction whose instruction to be executed next when the branch prediction is not hit is limited, comprising:
a first decoder, as a basic decoder, used for decoding a normal instruction; and
a second decoder, as a dedicated decoder, used for decoding an instruction to be executed next when the branch of the limited conditional branch instruction is not approved, wherein the instruction to be executed next is decoded within fewer machine cycles than required for a normal instruction;
wherein when it is detected that the branch is not approved by the first decoder in decoding the limited conditional branch instruction, the second decoder is used for the decode stage for the instruction to be executed next.

4. An instruction converter;
employing a limited conditional branch instruction whose instruction to be executed next when the branch prediction is not hit is limited;
wherein when detecting the conditional branch instruction in the inputted instruction sequence, checking the instruction to be executed next when the conditional branch is not approved, and checking whether the relationship between the conditional branch instruction and the instruction to be executed next when the branch is not approved corresponds to the relationship between the limited branch instruction and the instruction to be executed next when the branch is not approved, and if it corresponds, converting the conditional branch instruction to the limited conditional branch instruction.

5. A microprocessor having a branch prediction that the branch will not be approved,
employing a limited conditional branch instruction whose branch designation instruction to be executed next when the branch prediction is hit is limited;
wherein, if it is detected that the branch is approved in decode stage for the limited conditional branch instruction, a fetch stage and a decode stage for a branch designation instruction to be executed next are conducted within fewer machine cycles than required for a fetch stage and a decode stage for a normal instruction.

6. A microprocessor having a branch prediction that the branch will not be approved,
employing a limited conditional branch instruction whose branch designation instruction to be executed next when the branch prediction is hit is limited, comprising:
a first memory for storing instructions;
a second memory for storing op code of the branch designation instruction to be executed next when the branch prediction is hit;
wherein, if it is detected that the branch is approved in the decode stage for the limited conditional branch instruction, an op code is provided from the second memory to the decoder and an operand is provided from the first memory to the decoder.

7. A microprocessor having a branch prediction that the branch will not be approved,
employing a limited conditional branch instruction whose branch designation instruction to be executed next when the branch prediction is hit is limited, comprising:
a first decoder, as a basic decoder, used for decoding a normal instruction; and
a second decoder, as a dedicated decoder, used for decoding a branch designation instruction to be executed next when the branch is approved for the limited conditional branch instruction, wherein the branch designation instruction is conducted within fewer machine cycles than required for a normal instruction;
wherein when it is detected that the branch is approved by the first decoder in decoding the limited conditional branch instruction, the second decoder is used for the decode stage for the branch designation instruction to be executed next.

8. An instruction converter;
employing a limited conditional branch instruction whose branch designation instruction to be executed next when the branch prediction is hit is limited;
wherein when detecting the conditional branch instruction in the inputted instruction sequence, checking the branch designation instruction to be executed next when the conditional branch is approved, and checking whether the relationship between the conditional branch instruction and the branch designation instruction corresponds to the relationship between the limited branch instruction and the branch designation instruction, and if it corresponds, converting the conditional branch instruction to the limited conditional branch instruction.

9. A microprocessor employing a limited unconditional branch instruction whose branch designation instruction to be executed next is limited,
wherein, if the limited unconditional branch instruction is detected in a decode stage, a fetch stage and a decode stage for the branch designation instruction of the limited unconditional branch instruction are conducted within fewer machine cycles than required for a fetch stage and a decode stage for a normal instruction.

10. A microprocessor employing a limited unconditional branch instruction whose branch designation instruction to be executed next is limited, comprising:
a first memory for storing instructions;
a second memory for storing an op code of the branch designation instruction of the limited unconditional branch instruction;
wherein, if the limited unconditional branch instruction is detected in a decode stage, the op code is provided from the second memory to the decoder quickly and the operand is provided from the first memory to the decoder quickly.

11. A microprocessor employing a limited unconditional branch instruction whose branch designation instruction to be executed next is limited, comprising:
a first decoder used for decoding a normal instruction; and
a second decoder used for decoding a branch designation instruction of the limited unconditional branch instruction;
wherein the branch designation instruction is decoded quickly within fewer machine cycles than required for a normal instruction, and when the limited unconditional branch instruction is detected by the first decoder, the second decoder is used for the decode stage for the branch designation instruction of the limited unconditional branch instruction.

12. An instruction converter employing a limited unconditional branch instruction whose branch designation instruction to be executed next is limited,
wherein when detecting the unconditional branch instruction in an inputted instruction sequence, the instruction converter checks the instruction to be executed subsequent to the unconditional branch instruction, and checks whether the relationship between the branch designation instruction and the unconditional branch instruction corresponds to the relationship between the branch designation instruction and the limited unconditional branch instruction, and if it corresponds, converts the unconditional branch instruction to the limited unconditional branch instruction.

13. A method for driving a microprocessor having a branch prediction that a branch will be approved,
the microprocessor employing a limited conditional branch instruction whose instruction to be executed next when the branch prediction is not hit is limited;
wherein, if it is detected that the branch is not approved in decode stage for the limited conditional branch instruction, a fetch stage and a decode stage for the next instruction to be executed are conducted in fewer machine cycles than required for a fetch stage and a decode stage for a normal instruction.

14. A method for driving a microprocessor having a branch prediction that a branch will be approved,
the microprocessor employing a limited conditional branch instruction whose next instruction to be executed next when the branch prediction is not hit is limited, comprising:
storing instructions into a first memory; and
storing an op code of the instruction to be executed next when the branch prediction is not hit into a second memory;
wherein, if it is detected that the branch is not approved in a decode stage for the limited conditional branch instruction, an op code is provided from the second memory to a decoder and an operand is provided from the first memory to the decoder.

15. A method for driving a microprocessor having a branch prediction that a branch will be approved,
the microprocessor employing a limited conditional branch instruction whose instruction to be executed next when the branch prediction is not hit is limited, comprising:
in case of decoding a normal instruction, using a first decoder as a basic decoder; and
in case of decoding an instruction to be executed next when the branch of the limited conditional branch instruction is not approved, using a second decoder as a dedicated decoder, wherein the instruction to be executed next is decoded within fewer machine cycles than required for a normal instruction;
wherein when it is detected that the branch is not approved by the first decoder in decoding the limited conditional branch instruction, the second decoder is used for the decode stage for the instruction to be executed next.

16. A method for converting instructions for a microprocessor that
employs a limited conditional branch instruction whose instruction to be executed next when the branch prediction is not hit is limited;
wherein when a conditional branch instruction in an inputted instruction sequence is detected, the instruction to be executed next when the conditional branch is not approved is checked, and the relationship between the conditional branch instruction and the instruction to be executed next when the branch is not approved is checked to determine whether the relationship corresponds to the relationship between the limited branch instruction and the instruction to be executed next when the branch is not approved, and if it corresponds, converting the conditional branch instruction to the limited conditional branch instruction.

17. A method for driving a microprocessor having a branch prediction that a branch will not be approved,
the microprocessor employing a limited conditional branch instruction whose branch designation instruction to be executed next when the branch prediction is hit is limited;
wherein, if it is detected that the branch is approved in a decode stage for the limited conditional branch instruction, a fetch stage and a decode stage for a branch designation instruction to be executed next are conducted in fewer machine cycles than required for a fetch stage and a decode stage for a normal instruction.

18. A method for driving a microprocessor having a branch prediction that a branch will not be approved,
the microprocessor employing a limited conditional branch instruction whose branch designation instruction to be executed next when the branch prediction is hit is limited, comprising:
storing instructions in a first memory; and
storing an op code of the branch designation instruction to be executed next when the branch prediction is hit into a second memory;
wherein, if it is detected that the branch is approved in a decode stage for the limited conditional branch instruction, an op code is provided from the second memory to the decoder and an operand is provided from the first memory to the decoder.

19. A method for driving a microprocessor having a branch prediction that a branch will not be approved,
the microprocessor employing a limited conditional branch instruction whose branch designation instruction to be executed next when the branch prediction is hit is limited, comprising:
in case of decoding a normal instruction, using a first decoder as a basic decoder; and
in case of decoding a branch designation instruction to be executed next when the branch is approved for the limited conditional branch instruction, using a second decoder as a dedicated decoder, wherein the branch designation instruction is conducted within fewer machine cycles than required for a normal instruction;
wherein when it is detected that the branch is approved by the first decoder in decoding the limited conditional branch instruction, the second decoder is used for the decode stage for the branch designation instruction to be executed next.

20. A method for converting instructions for a microprocessor that
employs a limited conditional branch instruction whose branch designation instruction to be executed next when the branch prediction is hit is limited;
wherein when a conditional branch instruction in an inputted instruction sequence is detected, the branch designation instruction to be executed next when the conditional branch is approved is checked, and the relationship between the conditional branch instruction and the branch designation instruction is checked to determine whether the relationship corresponds to the relationship between the limited branch instruction and the branch designation instruction, and if it corresponds, converting the conditional branch instruction to the limited conditional branch instruction.

21. A method for driving a microprocessor employing a limited unconditional branch instruction whose branch designation instruction to be executed next is limited,
wherein, if the limited unconditional branch instruction is detected in a decode stage, a fetch stage and a decode stage for the branch designation instruction of the limited unconditional branch instruction are conducted within fewer machine cycles than required for a fetch stage and a decode stage for a normal instruction.

22. A method for driving a microprocessor employing a limited unconditional branch instruction whose branch designation instruction to be executed next is limited, comprising:
storing instructions in a first memory; and
storing an op code of the branch designation instruction of the limited unconditional branch instruction in a second memory;
wherein, if the limited unconditional branch instruction is detected in the decode stage, the op code is provided from the second memory to the decoder quickly and the operand is provided from the first memory to the decoder quickly.

23. A method for driving a microprocessor employing a limited unconditional branch instruction whose branch designation instruction to be executed next is limited, comprising:
in case of decoding a normal instruction, using a first decoder; and
in case of decoding a branch designation instruction of the limited unconditional branch instruction, using a second decoder;
wherein the branch designation instruction is decoded quickly, within fewer machine cycles than required for a normal instruction, when the limited unconditional branch instruction is detected by the first decoder, the second decoder is used for a decode stage for the branch designation instruction of the limited unconditional branch instruction.

24. A method for converting instructions for a microprocessor that
employs a limited unconditional branch instruction whose branch designation instruction to be executed next is limited,
wherein when an unconditional branch instruction in an inputted instruction sequence is detected, the instruction converter checks the instruction to be executed subsequent to the unconditional branch instruction, and checks whether the relationship between the branch designation instruction and the unconditional branch instruction corresponds to the relationship between the branch designation instruction and the limited unconditional branch instruction, and if it corresponds, converts the unconditional branch instruction to the limited unconditional branch instruction.
